(19) United States
(12) Patent Application Publication
(10) Pub. No.: US 2022/0197164 A1
(43) Pub. Date: Jun. 23, 2022

(54) TONER MANUFACTURING METHOD

(71) Applicant: CANON KABUSHIKI KAISHA, Tokyo (JP)

(72) Inventors: Junichi Tamura, Ibaraki (JP); Kazuhisa Shirayama, Tokyo (JP); Rei Hijikawa, Chiba (JP); Ryuji Okamura, Ibaraki (JP); Yuya Chimoto, Chiba (JP); Hisasuke Kajihara, Ibaraki (JP)

(21) Appl. No.: 17/545,597

(22) Filed: Dec. 8, 2021

(30) Foreign Application Priority Data
Dec. 17, 2020 (JP) 2020-209350

(51) Int. Cl. G03G 9/087; B24B 1/00; G03G 9/08

(52) U.S. Cl. CPC G03G 9/08755; G03G 9/0802; B24B 1/00

(57) ABSTRACT

A method for manufacturing a toner includes a pigment crushing step of kneading a pigment, a binder, and a grinding agent to obtain a pigment dispersion in which the grinding agent and the crushed pigment are dispersed in the binder; and a step of obtaining toner particles by a predetermined method using the pigment dispersion. The binder and the grinding agent are contained in the resulting toner particles.

### BACKGROUND OF THE INVENTION

### Field of the Invention

The present disclosure relates to a method for manufacturing a toner that is used in an electrophotographic system, an electrostatic recording system, an electrostatic printing system, or a toner jet system.

### Description of the Related Art

In recent years, electrophotographic full-color copier have become widespread and also have begun to be applied to the printing field. In the printing field, high speed, high image quality, and high productivity are required while corresponding to various media (paper types). In order to achieve high image quality, further expansion of coloring power is required, and for that purpose, it is effective to reduce the particle diameter of pigments (Japanese Patent Laid-Open No. 2013-20244). Accordingly, as a method for reducing the particle diameter of pigments, a solvent salt milling method has been known (Japanese Patent Laid-Open No. 3-84067). The solvent salt milling method is a method for obtaining a small particle diameter pigment by crushing a pigment having a large particle diameter through kneading the pigment with a water-soluble inorganic salt as grinding agent and a water-soluble organic solvent as a binder. However, when the method is applied to manufacturing a toner, a washing process for removing the water-soluble inorganic salt and the water-soluble organic solvent and a drying process accompanied thereby are necessary, resulting in significant deterioration in productivity. Accordingly, there has been a demand for a milling method that does not use an organic solvent as a binder.

### SUMMARY OF THE INVENTION

The present disclosure can solve the disadvantages mentioned above. That is, the present disclosure provides a method for manufacturing a toner without necessary of removing a grinding agent and a binder and capable of reducing the particle diameter of the pigment to be dispersed in the toner.

The present disclosure relates to a method for manufacturing a toner, comprising: a pigment crushing step of kneading a pigment, a binder, and a grinding agent to obtain a pigment dispersion in which the grinding agent and the crushed pigment are dispersed in the binder; and a step of obtaining toner particles by at least any one of the following processes (i) to (v) using the pigment dispersion, wherein the binder is a thermoplastic component that is water-insoluble and is a solid at 25°; the grinding agent is a particle that is water-insoluble and has a number average particle diameter of 0.1 to 5 μm; the proportion of the binder based on the mass of the pigment dispersion is 5 to 50 mass %; the mass ratio of the pigment to the grinding agent in the pigment dispersion is 0.2 to 1.5; in the pigment crushing step, the kneading is performed at a temperature at which the melt viscosity of the binder is 6000 Pa·sec or less; and the toner particles contain the binder and the grinding agent.

A process (i) for obtaining toner particles through a step of melt-kneading the pigment dispersion and a resin A and a step of pulverizing the resulting kneaded product;

A process (ii) for obtaining toner particles through a step of preparing a resin solution in which the pigment dispersion and a resin A are dissolved to an organic solvent, a step of dispersing the resulting resin solution in an aqueous medium and performing granulation to form a droplet particle A, and a step of removing the organic solvent contained in the droplet particle A;

A process (iii) for obtaining toner particles containing a resin A formed by polymerization of a polymerizable monomer through a step of mixing the pigment dispersion and the polymerizable monomer to prepare a polymerizable monomer composition, a step of dispersing the polymerizable monomer composition in an aqueous medium and performing granulation to form a droplet particle B, and a step of polymerizing the polymerizable monomer contained in the droplet particle B;

A process (iv) for obtaining toner particles through a step of mixing a dispersion liquid containing microparticles of the pigment dispersion and a dispersion liquid containing microparticles containing a resin A and aggregating these microparticles to form aggregate particles and a step of heating and fusing the aggregate particles; and

A process (v) for obtaining toner particles through a step of preparing a resin composition containing the pigment dispersion and a resin A, a step of preparing a dispersion liquid containing microparticles of the resin composition, a step of aggregating the microparticles to form aggregate particles, and a step of heating and fusing the aggregate particles.

The present disclosure can provide a method for manufacturing a toner without necessary of removing a grinding agent and a binder and capable of reducing the particle diameter of the pigment to be dispersed in the toner.

Further features of the present disclosure will become apparent from the following description of exemplary embodiments.

### DESCRIPTION OF THE EMBODIMENTS

Although it is required to reduce the particle diameter of a pigment in order to improve the coloring power, in a known solvent salt milling method, the grinding agent and the binder must be removed, and a washing process for removing them and a drying process accompanied thereby are additionally necessary, resulting in a reduction in productivity. The present inventors studied and, as a result, succeeded in manufacturing of a toner without performing additional processes by crushing a pigment using a water-insoluble grinding agent and a water-insoluble binder to prepare a pigment dispersion and manufacturing toner particles using the pigment dispersant.

In the present disclosure, it is important to use particles that are water-insoluble and have a number average particle diameter of 0.1 μm or more and 5.0 μm or less as a grinding agent. Within the above-mentioned range, even if the toner includes a grinding agent, charge retention ability, low-temperature fixability, and coloring power are not inhibited. Furthermore, the binder is a thermoplastic component that is water-insoluble and is a solid at 25° C. Kneading is performed using such a binder in a state in which the melt viscosity is 6000 Pa·sec or less. In this case, since the binder is a solid before kneading, the handling property is good, the viscosity is decreased during kneading for functioning as a binder, and the binder, when contained in a toner, does not inhibit the blocking resistance and the charge retention ability.

Furthermore, when the proportion of the binder is 5 to 50 mass % based on the mass of the pigment dispersion, a uniform dispersion state for crushing the pigment by the grinding agent is obtained, and a shear force due to the grinding agent is strongly applied to the pigment, resulting in efficient pigment crushing.

In addition, when the mass ratio of the pigment to the grinding agent in the pigment dispersion is 0.2 to 1.5, the amount of the grinding agent contained in the toner can be suppressed without deteriorating the pigment crushing property, and the charge retention ability, the low-temperature fixability, and the coloring power are not inhibited.

### Manufacturing Method of Pigment Crushing Step

A procedure of the pigment crushing step for obtaining a pigment dispersion in the manufacturing method of the present disclosure will then be described but is not limited thereto, and the details of the procedure do not matter as long as the procedure is a melt-kneading method having a heating mechanism for melting the binder and crushing the pigment to give a pigment dispersion.

First, a pigment, a grinding agent, and a binder are uniformly mixed and may be then kneaded. As a step of uniform mixing, a raw material mixing step will be described. In the raw material mixing step, predetermined amounts of at least a pigment, a grinding agent, and a binder are weighed, and they are mixed. Examples of the mixer include a double cone mixer, a V-type mixer, a drum-type mixer, a super mixer, a Henschel mixer, and a Nauta mixer.

Subsequently, the mixed raw materials are put into a melt kneader and are melted and kneaded at a temperature at which the melt viscosity of the binder is 6000 Pa·sec or less. In this melt-kneading step, the pigment is crushed by the grinding agent in the melt kneader to give a pigment dispersion. In the melt-kneading step, for example, a batch-type kneader, such as a kneader, a pressurized kneader, or a Banbury mixer, or a continuous kneader may be used, but a twin screw kneading extruder can be used.

### Raw Material of Pigment Dispersion

Raw materials that are used for preparing a pigment dispersion will then be described. Incidentally, as the raw materials, at least a pigment, a water-insoluble grinding agent, and a water-insoluble binder are included.

### Pigment

Examples of the pigment that can be contained in the pigment dispersion include the followings.

Examples of the pigment include known organic pigments and carbon black.

Examples of cyan pigments include a copper phthalocyanine compound and a derivative thereof, an anthraquinone compound, and a basic dye lake compound.

Examples of magenta pigments include a condensed azo compound, a diketopyrrolopyrrole compound, an anthraquinone compound, a quinacridone compound, a basic dye lake compound, a naphthol compound, a benzimidazolone compound, a thioindigo compound, and a perylene compound.

Examples of yellow pigments include a condensed azo compound, an isoindolinone compound, an anthraquinone compound, an azo metal complex, a methine compound, and an allylamide compound.

Examples of black pigments include carbon black and a pigment obtained by toning to black using the yellow pigment, the magenta pigment, and the cyan pigment.

The pigments can be used alone or as a mixture of two or more thereof.

The pigment before being subjected to the pigment crushing step is a roughly crushed pigment having a number average particle diameter of about 80 to 150 nm. The pigment dispersed in a pigment dispersion after the pigment crushing step can have a number average particle diameter of 30 to 65 nm, which improves the coloring power. The method for measuring the number average particle diameter of a pigment will be described later.

### Grinding Agent

As the grinding agent to be contained in the pigment dispersion, a water-insoluble agent can be used, and examples thereof include known water-insoluble inorganic salt particles, inorganic oxide particles, and mineral particles. Specifically, the examples include the followings.

Examples of inorganic salts include carbonates, sulfates, and chromates.

Examples of inorganic oxides include silica, alumina, titania, and strontium titanate.

Examples of minerals include kaolinite, talc, and barium sulfate.

Among the above-mentioned agents, the grinding agent can be a particle that does not affect the tint even if it is contained in a toner. Specifically, the agent can be a carbonate or the above-mentioned minerals, and in particular, calcium carbonate particles having a refractive index near that of the toner binder resin can be used.

The water-insoluble grinding agent is required to show a good pigment crushing property and not to affect a toner when contained therein. From this viewpoint, the number average particle diameter can be 0.1 to 5.0 μm or 0.2 to 1.0 μm. The method for measuring the number average particle diameter of a water-insoluble grinding agent will be described later.

The content of the water-insoluble grinding agent in toner particles may be suppressed to 20 mass % or less for not affecting the tint.

### Binder

The binder that can be contained in the pigment dispersion is water-insoluble thermoplastic component that is a solid at 25° C.

Incidentally, the binder in the present disclosure is a component that is a solid at 25° C. but has a melt viscosity of 6000 Pa·sec or less at the temperature at which heating, melt-kneading are performed.

The binder is not particularly limited as long as it is a material that less affects the tint, charge retention ability, and blocking resistance and may be a material that is usually used as a material constituting a toner. Examples thereof include amorphous and crystalline resins that are used as binder resins for toners; thermoplastic elastomers; and low molecular weight crystalline compounds that are used as a release agent or a plasticizer.

### Amorphous Resin

The amorphous resin will first be described. A pigment dispersion in which a crushed pigment is dispersed in an amorphous resin can be obtained by using the amorphous resin as a binder. When toner particles are manufactured by using such a pigment dispersion, the pigment is well dispersed, and the resulting toner has excellent coloring power.

The amorphous resin may be any resin that is generally used in a toner, and examples thereof include polyester, a styrene-acrylic acid copolymer, a polyolefin resin, a vinyl resin, a fluorine resin, a phenolic resin, a silicone resin, an epoxy resin, and a hybrid resin thereof. Among these resins, amorphous polyester, a styrene-acrylic acid copolymer, and a hybrid resin thereof, which have good charge retention ability and low-temperature fixability, may be used, and in particular, amorphous polyester may be used.

The content of the amorphous resin can be 20 mass % or more of the binder for dispersing the pigment in the toner and may be 50 mass % or more.

The glass transition temperature of the amorphous resin may be 30° C. to 80° C. or 50° C. to 70° C. When the glass transition temperature is 30° C. or more, the amorphous resin can be handled as a solid before the pigment crushing step. In addition, when the glass transition temperature is 80° C. or less, the influence on the low-temperature fixability of a toner can be suppressed.

The softening point (Tm) of the amorphous resin can be 80° C. to 200° C. or 100° C. to 150° C. When the softening point (Tm) is within the above-mentioned range, the influence on the blocking resistance and offset resistance of the toner can be reduced.

In addition, the SP value of the amorphous resin can be 21.0 to 24.0 (J/cm³)^{0.5}. In the above-mentioned range, the adhesion with paper and the charge retention ability can be well maintained.

In addition, a crystalline resin may be used as a binder together with the amorphous resin. When the crystalline resin is included, the viscosity of the pigment dispersion is appropriately reduced, the dispersibility of the grinding agent and the pigment is further improved, and the pigment crushing property is improved.

### Low Molecular Weight Crystalline Compound

The low molecular weight crystalline compound is a compound having a number average molecular weight (Mn) of 250 or more and 1000 or less.

When the number average molecular weight (Mn) of the low molecular weight crystalline compound is within the above-mentioned range, the melting point can be reduced, and the compound becomes a component that crystallizes immediately when cooled after kneading. As a result, the movement of the pigment is restricted, the aggregation of the pigment can be suppressed, and good pigment dispersion can be achieved.

Incidentally, the number average molecular weight (Mn) of the low molecular weight crystalline compound can be easily controlled by various known manufacturing conditions of the low molecular weight crystalline compound.

The number average molecular weight (Mn) of the low molecular weight crystalline compound can be measured by gel permeation chromatography (GPC) as follows.

Super-high grade 2,6-di-t-butyl-4-methylphenol (BHT) is added to o-dichlorobenzene for gel chromatography at a concentration of 0.10 mass % and is dissolved at room temperature. A low molecular weight crystalline compound and the o-dichlorobenzene mixed with BHT are put in a sample bottle and are heated on a hot plate set to 150° C. to melt the low molecular weight crystalline compound.

The low molecular weight crystalline compound after melted is put on a filter unit heated in advance and is set to the main body. The compound passed through the filter unit is defined as a GPC sample.

Incidentally, the sample solution is prepared to have a concentration of about 0.15 mass %.

Measurement of this sample solution is performed under the following conditions.

Apparatus: HLC-8121 GPC/HT (manufactured by Tosoh Corporation)
Detector: RI for high temperature
Column: TSK gel GMHHR-H HT two series (manufactured by Tosoh Corporation)

### Temperature: 135.0° C.

Solvent: o-dichlorobenzene for gel chromatography
(including 0.10 mass % of BHT)
   Flow rate: 1.0 mL/min
   Injection volume: 0.4 mL

In calculation of the molecular weight of the low molecular weight crystalline compound, a molecular weight calibration curve produced using standard polystyrene resins (trade name “TSK Standard Polystyrene F-850, F-450, F-288, F-128, F-80, F-40, F-20, F-10, F-4, F-2, F-1, A-5000, A-2500, A-1000, and A-500”, manufactured by Tosoh Corporation) is used.

The melting point of the low molecular weight crystalline compound can be 60° C. to 120° C. or 70° C. to 100° C. In this case, since the grindability is excellent, an effect of reducing the hardness of the pigment crushed product after kneading and cooling is obtained. As a result, the pulverizing energy is reduced, and the productivity can be improved.

Examples of the low molecular weight crystalline compound include those used as the release agent for a toner, i.e., hydrocarbon waxes, such as low molecular weight polyethylene, low molecular weight polypropylene, an alkylene copolymer, a microcrystalline wax, a paraffin wax, and a Fischer-Tropsch wax; oxides of hydrocarbon waxes, such as a polyethylene oxide wax, and block copolymers thereof; waxes of which the main components are fatty acid esters, such as a carnauba wax; and waxes in which a fatty acid ester is partially or entirely deoxidized, such as deoxidized carnauba wax.

In addition, the examples include long chain alkylcarboxylic acids having crystallinity, such as stearic acid and behenic acid, and long chain alkyl alcohols having crystallinity, such as 1-docosanol and 1-octacosanol.

The content of the low molecular weight crystalline compound can be 20 mass % or more or 50 mass % or more in the water-insoluble binder for dispersing the pigment in the toner.

### Crystalline Resin

The crystalline resin may be any crystalline resin that is generally used in a toner, and examples thereof include polyester, polyamide, polyimide, polyolefin, polyethylene, polybutylene, polyisobutylate, polyvinyl, an ethylene-propylene copolymer, an ethylene-vinyl acetate copolymer, polypropylene, and an acrylic resin. In particular, crystalline polyester and crystalline acrylic resin can be used.

Furthermore, the crystalline acrylic resin may have a monomer unit represented by the following formula. The monomer unit represented by the following formula is formed by copolymerization using a (meth)acrylate including an alkyl group having 18 to 36 carbon atoms.

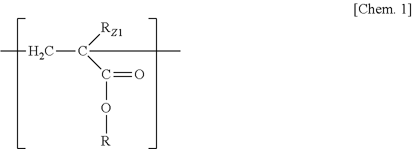

[In the formula, R_{Z1} represents a hydrogen atom or a methyl group, and R represents an alkyl group having 18 to 36 carbon atoms.]

Examples of the (meth)acrylate including an alkyl group having 18 to 36 carbon atoms include stearyl (meth)acrylate, nonadecyl (meth)acrylate, eicosyl (meth)acrylate, heneicosanyl (meth)acrylate, behenyl (meth)acrylate, lignoceryl (meth)acrylate, ceryl (meth)acrylate, octacosa (meth)acrylate, myricyl (meth)acrylate, dotriacontane (meth)acrylate, and 2-decyltetradecyl (meth)acrylate.

Among these (meth)acrylates, from the viewpoint of low-temperature fixability, the (meth)acrylate may be at least one selected from the group consisting of (meth)acrylates including a linear alkyl group having 18 to 36 carbon atoms, at least one selected from the group consisting of (meth)acrylates including a linear alkyl group having 18 to 30 carbon atoms, or at least one of linear stearyl (meth)acrylate and behenyl (meth)acrylate.

In addition, the crystalline resin may have a melting point of 60° C. to 120° C., 70° C. to 100° C., or 70° C. to 90° C. In such a case, since the grindability is excellent, an effect of reducing the hardness of the pigment crushed product after kneading and cooling is obtained. As a result, the pulverizing energy is reduced, and the productivity can be improved.

### SP Value of Binder

The step of obtaining toner particles goes through a state in which the amorphous resin used as a binder, a low molecular weight crystalline compound or a crystalline resin, and another resin (resin A) coexist, and the difference between the SP values of the binder component and the other resin (resin A) can be 3.0 (J/cm³)^{0.5} or less.

The SP value can be determined using Fedors equation. Here, the values of Δei and Δvi are referred from the evaporation energies and molar volumes (25° C.) of atoms and atomic groups in Tables 3 to 9 of the book “Basic Science of Coating”, pp. 54-57, 1986 (Maki Shoten).

δi=[Ev/V]^{(1/2)}=[Δei/Δvi]^{(1/2)} Equation:

Ev: evaporation energy
V: molar volume
Δei: evaporation energy of the atom or atomic group of i component
Δvi: molar volume of the atom or atomic group of i component

### Raw Material of Toner

The components contained in a toner particles will then be described.

The toner manufactured by the manufacturing method of the present disclosure contains components that are contained in general toners. Specifically, the toner contains, for example, a binder resin, a release agent, and a charge control agent.

### Binder Resin

The step of obtaining toner particles goes through a state in which a pigment dispersion and a resin (resin A) coexist. When the pigment dispersion contains a resin component that functions as a binder resin, the resin component contained in the pigment dispersion and the resin (resin A) mixed with the pigment dispersion function as binder resins in the toner particles. In contrast, when the pigment dispersion does not contain a resin component, the mixed resin (resin A) functions as a binder resin in the toner particles. Incidentally, the pigment dispersion and the resin may be mixed so that the proportion of the pigment in the toner particles is within a range of 3 to 20 mass %.

In the step of manufacturing toner particles, as the mixed or synthesized resin (resin A), a resin that is generally used as a binder resin for a toner can be used. Specifically, examples thereof include polyester, a polyolefin resin, a vinyl resin (styrene-(meth)acrylate copolymer), a fluorine resin, a phenolic resin, a silicone resin, and an epoxy resin. Among these resins, from the viewpoint of improving the low-temperature fixability, amorphous polyester may be used. As the amorphous polyester, from the viewpoint of simultaneously achieving low-temperature fixability and hot-offset resistance, a low molecular weight polyester and a high molecular weight polyester may be used in combination. In addition, from the viewpoint of further improving the low-temperature fixability and blocking resistance during storage, crystalline polyester may be contained.

### Method for Manufacturing Toner Particles

Examples of the method for obtaining toner particles using the pigment dispersion obtained in the pigment crushing step include a kneading crushing method, a dissolution suspension method, a suspension polymerization method, and an emulsification aggregation method. Toner particles may be manufactured by any of these methods alone or may be manufactured by a combination of these methods.

As needed, inorganic microparticles, such as silica, alumina, titania, and calcium carbonate, or resin microparticles, such as a vinyl resin, a polyester resin, and a silicone resin, may be added to the produced toner particles by applying a shear force to the toner particles in a dry state. These inorganic microparticles and resin microparticles function as external additives, such as a flow auxiliary or a cleaning auxiliary.

Methods for manufacturing toner particles in the kneading crushing method, the dissolution suspension method, the suspension polymerization method, and the emulsification aggregation method will now be specifically described.

### Kneading Crushing Method

In the kneading crushing method, first, a pigment dispersion, resin A, and, as needed, a release agent, a coloring agent, and other additives are sufficiently mixed with a mixer. Subsequently, the resulting mixture is melted and kneaded using a thermal kneader (kneading process). Then, the resulting needed substance is pulverized to obtain a desired toner particle diameter (pulverization process), and classification for obtaining a desired particle size distribution is performed as needed (classification process) to obtain toner particles.

Examples of the mixer include Henschel mixer (manufactured by Mitsui Kozan K.K.); Super mixer (manufactured by Kawata Co., Ltd.); Ribocone (manufactured by Okawara Mfg. Co., Ltd.); Nauta mixer, Turbulizer, and Cyclomix (manufactured by Hosokawa Micron Corporation); Spiralpin mixer (manufactured by Pacific Machinery & Engineering Co., Ltd.); and Loedige mixer (manufactured by Matsubo Corporation).

Examples of the thermal kneader include KRC kneader (manufactured by Kurimoto, Ltd.); Buss Co-Kneader (manufactured by Buss AG); TEM extruder (manufactured by Shibaura Machine Co., Ltd.); TEX biaxial kneader (manufactured by The Japan Steel Works, Ltd.); PCM kneader (manufactured by Ikegai Corporation); triple roll mill, mixing roll mill, and kneader (manufactured by Inoue Mfg. Inc.); Kneadex (manufactured by Mitsui Kozan Co., Ltd.); MS-type pressure kneader and Kneader Ruder (manufactured by Moriyama Manufacturing Co., Ltd.); and Banbury mixer (manufactured by Kobe Steel, Ltd.).

In the pulverization process, a known pulverizer, such as a collision plate type jet mill, a fluidized bed type jet mill, and a rotary mechanical mill, can be used. Specific examples include Counter Jet Mill, Micron Jet, and Innomizer (manufactured by Hosokawa Micron Corporation); IDS type mill and PJM Jet Pulverizer (manufactured by Nippon Pneumatic Mfg. Co., Ltd.); Cross Jet Mill (manufactured by Kurimoto, Ltd.); Ulmax (manufactured by Nisso Engineering Co., Ltd.); SK Jet-O-mill (manufactured by Seishin Enterprise Co., Ltd.); Kryptron (manufactured by Kawasaki Heavy Industries, Ltd.); Turbo Mill (manufactured by Freund-Turbo Corporation); and Super Rotor (manufactured by Nisshin Engineering Inc.).

Examples of the classifier that is used in the classification process include known apparatuses, such as a wind power classifier, an inertial classifier, and a sieve classifier. Specific examples include Classiel, Micron Classifier, and Spedic Classifier (manufactured by Seishin Enterprise Co., Ltd.); Turbo Classifier (manufactured by Nisshin Engineering Inc.); Micron Separator, Turboprex (ATP), and TSP Separator (manufactured by Hosokawa Micron Corporation); Elbow Jet (manufactured by Nittetsu Mining Co., Ltd.); Dispersion Separator (manufactured by Nippon Pneumatic Mfg. Co., Ltd.); and YM Microcut (manufactured by Yasukawa Shoji K.K.).

### Dissolution Suspension Method

In the dissolution suspension method, a toner is manufactured through a resin dissolution process, a granulation process, a solvent removal process, and a washing and drying process.

### Resin Dissolution Process

The resin dissolution process is a step of preparing a resin solution by dissolving a pigment dispersion and a resin A in an organic solvent. As needed, for example, another resin, a plasticizer, a coloring agent, and a release agent may be dissolved or dispersed in the organic solvent.

As the organic solvent, an organic solvent that can dissolve the binder and the resin A in the pigment dispersion can be arbitrarily used. Specific examples thereof include toluene and xylene.

The use amount of the organic solvent is not limited as long as a viscosity allowing dispersion of the resin composition in an aqueous medium and granulation. Specifically, the mass ratio of the resin composition including a pigment dispersion, a resin A, and as needed, another resin, a plasticizer, a coloring agent, etc. and the organic solvent can be 10/90 to 50/50 from the viewpoint of the granulation property and the production efficiency of a toner.

In contrast, the pigment, the grinding agent, and the coloring agent and release agent that are contained as needed in the pigment dispersion are not necessarily dissolved in the organic solvent and may be dispersed. When the coloring agent and the release agent are used in a dispersed state, dispersion may be performed using a disperser, such as a bead mill.

### Granulation Process

The granulation process is a step of dispersing the resulting resin solution in an aqueous medium containing a dispersant and performing granulation to obtain a predetermined toner particle diameter to prepare a dispersion (granulated substance) in which the droplet particle A is dispersed. As the aqueous medium, water is mainly used. In addition, the aqueous medium may contain 1 mass % or more and 30 mass % or less of a monovalent metal salt. When a monovalent metal salt is contained, the organic solvent in the resin solution is prevented from diffusing into the aqueous medium, and the particle size distribution of the toner is likely to become sharp.

Examples of the monovalent metal salt include sodium chloride, potassium chloride, lithium chloride, and potassium bromide, and among these metal salts, sodium chloride or potassium chloride may be used.

In addition, the mixing ratio (mass ratio) of the aqueous medium and the resin solution may be aqueous medium/resin solution=90/10 to 50/50.

The dispersant is not particularly limited. As an organic dispersant, a cationic, anionic, or nonionic surfactant is used, and an anionic surfactant may be used. Examples of the organic dispersant include sodium alkylbenzene sulfonate, sodium α-olefin sulfonate, sodium alkylsulfonate, and sodium alkyldiphenyl ether disulfonate. As inorganic dispersants, for example, tricalcium phosphate, hydroxyapatite, calcium carbonate, titanium oxide, and silica powder are mentioned. In particular, from the viewpoint of stability of granulation, tricalcium phosphate, which is an inorganic dispersant, may be used.

The addition amount of the dispersant is determined depending on the particle diameter of the granulated substance. The particle diameter decreases with an increase in the addition amount of the dispersant. Accordingly, although the addition amount of a dispersant varies depending on the desired particle diameter, the amount can be 0.1 to 15 parts by mass with respect to 100 parts by mass of the resin solution. When the amount is 0.1 parts by mass or more, coarse powder is unlikely to be generated. When the amount is 15 parts by mass or less, unnecessary fine particles are unlikely to be generated.

Preparation of a dispersion of a resin solution in an aqueous medium may be performed under high speed shearing. The dispersion of the resin solution dispersed in the aqueous medium may be granulated to a volume average particle diameter of 10 μm or less or about 4 to 9 μm.

Examples of the apparatus giving high speed shearing include various high speed dispersers and ultrasonic dispersers.

### Solvent Removal Process

The solvent removal process is a step for removing the organic solvent from the droplet particle A. The organic solvent may be removed while stirring. In addition, as needed, the speed of removing the organic solvent can be controlled by heating and reducing pressure.

### Washing and Drying Process

After the solvent removal process, a washing and drying process of washing with, for example, water several times and filtrating and drying toner particles may be carried out. When a dispersant that is dissolved under acidic conditions, such as tricalcium phosphate, is used, washing with water may be carried out after washing with hydrochloric acid or the like. Washing can remove the dispersant used for granulation and can improve the toner characteristics.

### Suspension Polymerization Method

First, a polymerizable monomer, a pigment dispersion, and other necessary components (for example, a release agent, a crosslinking agent, a charge control agent, a chain transfer agent, a plasticizer, a pigment dispersant, a release agent, and a dispersant) are mixed and dissolved or dispersed to prepare a polymerizable monomer composition. On this occasion, a disperser, such as a homogenizer, a ball mill, a colloid mill, or an ultrasonic disperser, can be used. Subsequently, the polymerizable monomer composition is put into an aqueous medium and is dispersed (suspended) using a high speed disperser, such as a high speed stirrer or an ultrasonic disperser, for granulation to form a droplet particle B. The aqueous medium may contain a dispersion stabilizer. A polymerization initiator may be mixed together with another additive when the polymerizable monomer composition is prepared or may be added to the aqueous medium immediately before performing dispersion. In addition, during or after granulation, i.e., immediately before starting the polymerization reaction, a polymerization initiator can also be added in a state dissolved in a polymerizable monomer or another solvent as needed. Then, a polymerization reaction is performed while stirring so that the particle state of the droplet particles of the polymerizable monomer composition in the suspension is maintained and that floating and precipitation of the particles do not occur to polymerize the polymerizable monomer contained in the droplet particle B to form resin particles. Subsequently, the suspension is cooled, washed as needed, and dried and classified by various methods to obtain toner particles. Incidentally, the resulting toner particles contain the resin A generated by polymerization of the polymerizable monomer.

### Emulsification Aggregation Method

In the emulsification aggregation method, a toner is manufactured through a microparticle dispersion liquid preparing process, an aggregation process, a fusion process, a cooling process, and a washing process. A method of manufacturing a toner using the emulsification aggregation method will now be specifically described but is not limited thereto.

### Process for Preparing Microparticle Dispersion Liquid

First, preparation of a dispersion liquid of resin microparticles will be described. The resin microparticles can be manufactured by a known method but may be produced by the following method.

A resin (for example, a polyester resin) is dissolved in an organic solvent to form a uniform solution. Subsequently, a basic compound and a surfactant are added as needed. Furthermore, microparticles are formed by slowly adding an aqueous medium to the solution while applying shear with a homogenizer or the like or by applying shear with a homogenizer or the like after addition of an aqueous medium. The solvent is then removed to obtain a resin microparticle dispersion liquid in which the resin microparticles are dispersed.

The concentration of the resin to be dissolved in an organic solvent may be 10 mass % or more and 50 mass % or less or 30 mass % or more and 50 mass % or less. The organic solvent may be any solvent that can dissolve the resin and may be, for example, toluene, xylene, or tetrahydrofuran.

The surfactant is not particularly limited, and examples thereof include sulfate-based, sulfonate-based, carboxylate-based, phosphate-based, and soap-based anionic surfactants; amine salt-type and quaternary ammonium salt-type cationic surfactants; and polyethylene glycol-based, alkylphenol ethylene oxide adduct-based, and polyhydric alcohol-based nonionic surfactants.

Examples of the base include inorganic bases, such as sodium hydroxide and potassium hydroxide; and organic bases, such as triethylamine, trimethylamine, dimethylaminoethanol, and diethylaminoethanol. The bases may be used alone or in combination of two or more.

The median diameter based on the volume of the resin microparticles may be 0.05 to 1.0 μm or 0.1 to 0.6 μm. When the median diameter is within this range, toner particles having a desired particle diameter are likely to be obtained. Incidentally, the median diameter based on the volume can be measured using a dynamic light scattering particle size analyzer (Nanotrac UPA-EX150: manufactured by Nikkiso Co., Ltd.).

Preparation of a microparticle dispersion liquid of the pigment dispersion will then be described. When a dispersion liquid (emulsion) containing microparticles of the pigment dispersion is produced alone, the pigment dispersion, a surfactant, and an aqueous medium are mixed, the temperature is raised to a temperature at which the binder in the pigment dispersion is melted, shear is applied with a homogenizer or the like, and cooling is then performed to obtain a dispersion liquid of pigment dispersion in which the pigment dispersion is dispersed in the aqueous medium.

Incidentally, a microparticle dispersion containing a pigment dispersion and a resin A may be prepared without separately preparing a dispersion liquid of resin microparticles and a dispersion liquid of a pigment dispersion. In this case, in the process of preparing a resin microparticle dispersion liquid, a dispersion liquid of microparticles containing the resin A and the pigment dispersion is obtained by adding the pigment dispersion when the resin is dissolved in an organic solvent.

### Aggregation Process

As needed, for example, a release agent microparticle dispersion liquid is mixed with the dispersion liquid of the resin microparticles and the dispersion liquid of the pigment dispersion to prepare a mixture solution. Incidentally, instead of using the dispersion liquid of the resin microparticles and the dispersion liquid of the pigment dispersion, a dispersion liquid of microparticles containing a resin and a pigment dispersion may be used. Subsequently, the microparticles included in the prepared mixture solution are allowed to aggregate to form aggregate particles. The method for forming the aggregate particles may be, for example, a method of adding a flocculant to the mixture solution and mixing them and raising the temperature or appropriately applying a mechanical power or the like.

The dispersion liquid of release agent microparticles that is used as needed in the aggregation process is prepared by dispersing the above-mentioned release agent. The release agent microparticles are dispersed by a known method. For example, a release agent and an aqueous medium are mixed, the temperature is raised until the release agent is melted, shearing is performed using a media type disperser, such as a rotary shear homogenizer, a ball mill, a sand mill, or an attritor, or a high-pressure counter collision type disperser, and cooling is then performed to obtain a release agent dispersion liquid in which the release agent is dispersed in the aqueous medium. In addition, as needed, a surfactant or a high molecular dispersant for providing dispersion stability may be added.

Examples of the flocculant that is used in the aggregation process include metals salts of monovalent metals such as sodium and potassium; metals salts of divalent metals such as calcium and magnesium; metal salts of trivalent metals such as iron and aluminum; and polyvalent metal salts such as polyaluminum chloride. Divalent metal salts, such as calcium chloride and magnesium sulfate, may be used from the viewpoint of the particle diameter controlling property of the aggregation process.

The mixing of the flocculant may be performed within a temperature range of room temperature (25° C.) to 75° C. When the mixing is performed within this temperature condition, aggregation progresses stably. The mixing can be performed using a known mixer, such as a homogenizer and a mixer.

The average particle diameter of the aggregate particles formed in the aggregation process is not particularly limited, and usually, the weight average particle diameter can be controlled to 4.0 to 7.0 μm so as to be about the same as the average particle diameter of the toner particles to obtain. The control can be easily performed by, for example, appropriately setting and changing the temperature when the flocculant, etc. are added and mixed and the conditions of stirring and mixing. Incidentally, the particle size distribution of the aggregate particles can be measured with a particle size distribution analyzer (Coulter Multisizer III, manufactured by Beckman Coulter, Inc.) by a Coulter method.

### Fusion Process

The fusion process is a step for forming toner particles prepared by smoothing the aggregate particle surface through heating and fusing the aggregate particles. Before starting the fusion process, in order to prevent melt-adhesion between particles, a chelating agent, a pH adjuster, a surfactant, and so on can be appropriately put into the process.

Examples of the chelating agent include alkali metal salts, such as ethylenediaminetetraacetic acid (EDTA) and alkali metal salts thereof such as a Na salt; sodium gluconate, sodium tartrate, potassium citrate, and sodium citrate; a nitrilotriacetate (NTA) salt; and many water-soluble polymers (polymer electrolytes) having the functionality of both COOH and OH.

The temperature of heating is higher than the glass transition temperature of the resin contained in the aggregate and less than the temperature at which the resin thermally decomposes. When the heating temperature is high, the time of heating may be short. When the heating temperature is low, a long time is required. That is, since the time for heating and fusing depends on the heating temperature, it cannot be unequivocally specified, but the heating time is usually 10 minutes to 10 hours.

### Cooling Process

The cooling process is a step of decreasing the temperature of the aqueous medium containing the particles obtained in the fusion process to a temperature lower than the glass transition temperature of the resin. Cooling to a temperature lower than the glass transition temperature can suppress occurrence of coarse particles. A specific cooling rate is 0.1 to 50° C./min.

### Washing Process

Impurities in the toner particles can be removed by repeating washing and filtration of the particles produced through the above described processes. Specifically, toner particles can be washed with an aqueous solution containing a chelating agent, such as ethylenediaminetetraacetic acid (EDTA) or its Na salt, and further with deionized water. In the washing with deionized water, a metal salt, a surfactant, etc. in the toner particles can be removed by repeating filtration several times. The number of filtrations may be 3 to 20 times or 3 to 10 times from the viewpoint of manufacturing efficiency.

### Drying Process

Toner particles can be obtained by drying the particles obtained in the above-described process.

The methods for measuring various physical properties of a toner and raw materials will now be described.

### Measurement of Number Average Particle Diameters of Pigment and Grinding Agent

The number average particle diameters of a pigment and a grinding agent are measured using a transmission electron microscope (TEM) “JEM-2800” (manufactured by JEOL Ltd.).

First, a measurement sample is prepared. One milliliter of deionized water containing a dispersible surfactant is added for about 5 mg of a pigment or a grinding agent, followed by dispersion with an ultrasonic disperser (ultrasonic washer) for 5 minutes. Subsequently, one drop of the above dispersion liquid is added to a microgrid (150 mesh) equipped with a support film for TEM and is dried to prepare a measurement sample.

Subsequently, an image is acquired by the transmission electron microscope (TEM) under a condition of an acceleration voltage of 200 kV at a magnification (for example, 20 k to 100 k magnification) that allows the length of the pigment or grinding agent in the field of view to be sufficiently measured, and the particle diameters of 100 primary particles of the pigment or grinding agent are randomly measured to determine the number average particle diameter. The particle diameter of primary particles may be measured manually or by using a measurement tool.

When the number average particle diameter of a pigment contained in the pigment dispersion after the pigment crushing step is measured, it is necessary to extract the pigment from the pigment dispersion. An example thereof will now be described.

In order to dissolve a binder in a pigment dispersion with a solvent, the solvent is selected depending on the type of the binder, and the binder is melted using, for example, a swing roll mixer. For example, if the binder is an amorphous polyester resin, tetrahydrofuran, methyl ethyl ketone, or the like can be used. Subsequently, filtration and washing are performed to separate the binder from the pigment dispersion to extract a mixture of the pigment and the grinding agent. The extracted mixture of the pigment and the grinding agent is observed as in the above method, and only the pigment is extracted based on the shapes of the pigment and the grinding agent, and the number average particle diameter is measured manually or by using a measurement tool.

### Measurement of Glass Transition Temperature (Tg) of Resin

The glass transition temperature of a resin is measured using a differential scanning calorie analyzer “Q2000” (manufactured by TA Instruments) in accordance with ASTM D3418-82.

The temperature correction of the analyzer detecting unit is performed using the melting points of indium and zinc, and the calorie correction is performed using the heat of fusion of indium.

Specifically, about 5 mg of a resin is precisely weighted and is put in an aluminum pan. As a reference, a vacant aluminum pan is used. The measurement is performed within a measurement range of 30° C. or more and 180° C. or less at a temperature rising rate of 10° C./min.

Once, the temperature is raised to 180° C., and the temperature is maintained for 10 minutes, is subsequently decreased to 30° C., and is then raised again. In the second temperature elevating process, a change in specific heat is obtained within a temperature range of 30° C. or more and 100° C. or less. The temperature at the intersection of a straight line equidistant in the vertical axis direction from the straight lines extending the baselines before and after the change in specific heat on this occasion and the curve of the stepwise change part of the glass transition in the DSC curve is defined as the glass transition temperature (Tg: ° C.) of the resin.

### Measurement of Peak Temperature (Melting Point) of Endothermal Peak

The peak top temperature (melting point) of the maximum endothermal peak of, for example, a crystalline resin or a release agent is measured using a differential scanning calorie analyzer “Q1000” (manufactured by TA Instruments) in accordance with ASTM D3418-82.

The temperature correction of the analyzer detecting unit is performed using melting points of indium and zinc, and the calorie correction is performed using the heat of fusion of indium.

Specifically, about 5 mg of a sample is precisely weighted and is put in a silver pan, and measurement is performed once. As a reference, a vacant pan is used. The measurement conditions are as follows.

Temperature rising rate: 10° C./min
Measurement starting temperature: 20° C.
Measurement end temperature: 180° C.

Incidentally, the maximum endothermal peak means the peak at which the endothermic energy amount is the maximum when a plurality of peaks is present. In addition, the peak temperature of the maximum endothermal peak is defined as a melting point.

### Measurement of Melt Viscosity and Softening Point (Tm) of Resin

The melt viscosity and the softening point (Tm) of a resin can be measured using a constant load extrusion type capillary rheometer “flow characteristic evaluation device Flow Tester CFT-500D” (manufactured by Shimadzu Corporation).

Incidentally, CFT-500D is an apparatus of extruding a measurement sample from the hole of a thin tube at the bottom of a cylinder while applying a constant load from the top with a piston and melting the measurement sample packed in the cylinder by raising the temperature and can made a graph of the flow curve from the descending amount (mm) of the piston and the temperature (° C.) on this occasion.

In the present disclosure, the melt viscosity is the value (Pa·sec) obtained by dividing the shear stress (Pa) obtained by measuring a sample using a “flow characteristic evaluation device Flow Tester CFT-500D” by the shear velocity (sec′) at each heating temperature, i.e., “shear stress/shear velocity at each heating temperature”.

In the present disclosure, the “melting temperature in ½ method” described in the manual attached to the “flow characteristic evaluation device flow tester CFT-500D” is used as the softening point (Tm).

Incidentally, the melting temperature in ½ method is calculated as follows.

First, ½ of the difference between the descending amount of the piston at the time of ending outflow (the outflow ending point, referred to as Smax) and the descending amount of the piston at the time of starting outflow (the lowest point, referred to as Smin) is determined (this is defined as X, X=(Smax−Smin)/2). The temperature at which the descending amount of the piston is the sum of X and Smin in the flow curve is defined as melting temperature in ½ method.

The measurement sample is prepared by compression molding of 1.2 g of a resin using a tablet compression molding device (for example, standard manual type Newton Press NT-100H, manufactured by NPa SYSTEM Co., Ltd.) at 10 MPa under an environment of 25° C. for 60 seconds into a columnar shape with a diameter of 8 mm.

A specific procedure in the measurement is performed according to the manual attached to the device.

The measurement conditions of CFT-500D are as follows.

Test mode: temperature raising method
Start temperature: 40° C.
End-point temperature: 200° C.
Measurement interval: 1.0° C.
Temperature rising rate: 4.0° C./min
Piston sectional area: 1.000 cm²
Test load (piston load): 5.0 kgf
Preheating time: 300 seconds
Diameter of the hole of die: 1.0 mm

### Length of die: 1.0 mm

### Method for Measuring Weight Average Particle Diameter (D4) of Toner Particles

The weight average particle diameter (D4) of toner particles is obtained by measurement using a precise particle size distribution measuring apparatus “Coulter Counter Multisizer 3” (registered trademark, manufactured by Beckman Coulter, Inc.) equipped with a 50 μm aperture tube by an aperture impedance method and the dedicated software “Beckman Coulter Multisizer 3 Version 3.51” (manufactured by Beckman Coulter, Inc.) supplied for setting the measurement conditions and measurement data analysis at 25000 effective measuring channels, analyzing the measurement data, and performing calculation.

The electrolytic aqueous solution to be used for measurement is prepared by dissolving super-high grade sodium chloride in deionized water at a concentration of about 1 mass %, and, for example, “ISOTON II” (manufactured by Beckman Coulter, Inc.) can be used.

Incidentally, before performing measurement and analysis, the dedicated software is set as follows.

In the “screen of changing standard measurement method (SOM)” of the dedicated software, the total count number of the control mode is set to 50000 particles, the number of measurement is set to once, and the Kd value is set to the value obtained using “standard particles 10.0 μm” (manufactured by Beckman Coulter, Inc.). The threshold and the noise level are automatically set by pushing the threshold/noise level measurement bottom. In addition, the current is set to 1600 μA, the gain is set to 2, the electrolyte is set to ISOTON II, and the flush of the aperture tube after measurement is checked.

In the “screen of conversion setting from pulse to particle diameter” of the dedicated software, the bin spacing is set to logarithmic particle diameter, the particle diameter bin is set to 256 particle diameter bins, and the particle diameter range is set to 1 μm or more and 30 μm or less.

The specific measuring method is as follows:

(1) About 200 mL of the electrolytic aqueous solution is put in a 250-mL glass round bottom beaker for Multisizer 3, the beaker is set to the sample stand, and stirring by a stirrer rod is performed counterclockwise at 24 rpm. Dirt and air bubbles inside the aperture tube are removed by the “flush of aperture” function of the analysis software;
(2) About 30 mL of the electrolytic aqueous solution is put in a 100-mL glass flat bottom beaker, and about 0.3 mL of a diluted solution prepared by diluting “Contaminon N” (10 mass % of an aqueous solution of a neutral detergent for precise measuring equipment washing consisting of a nonionic surfactant, an anionic surfactant, and an organic builder and having pH 7, manufactured by FUJIFILM Wako Pure Chemical Corporation) with deionized water by 3 times by mass is added to the beaker as a dispersant;
(3) A predetermined amount of deionized water is placed in the water tank of an ultrasonic disperser “Ultrasonic Dispension System Tetora 150” (manufactured by Nikkaki Bios Co., Ltd.) equipped with two built-in oscillators of an oscillating frequency of 50 kHz with their phases shifted by 180 degrees and having an electrical output of 120 W, and about 2 mL of the Contaminon N is added to this water tank;
(4) The beaker in the (2) is set to the beaker fixing hole of the ultrasonic disperser, and the ultrasonic disperser is activated. The beaker height position is adjusted such that the resonant state of the surface of the electrolytic aqueous solution in the beaker is the maximum;
(5) With the electrolytic aqueous solution in the beaker of the (4) irradiated with ultrasonic waves, about 10 mg of a toner is added little by little to the electrolytic aqueous solution and is dispersed therein, and ultrasonic dispersion treatment is further continued for 60 seconds. Incidentally, in the ultrasonic dispersion, the water temperature of the water tank is appropriately controlled to 10° C. or more and 40° C. or less;
(6) The electrolyte aqueous solution of the (5) in which the toner is dispersed is dropwise added to the round bottom beaker of the (1) set to the sample stand using a pipette, and the measurement concentration is adjusted to about 5%. Measurement is performed until the number of the measurement particles becomes 50000; and
(7) The measurement data are analyzed with the dedicated software attached to the apparatus, and the weight average particle diameter (D4) is calculated. Incidentally, the “average diameter” of analysis/volume statistical value (arithmetic mean) screen when the graph/vol % is set by the dedicated software is the weight average particle diameter (D4).

### EXAMPLES

In the following Examples, the part(s) is based on mass unless otherwise specified.

Manufacturing of Pigment Dispersion A-1

Pigment: 35 parts
(Cyan pigment: Pigment Blue 15:3, number average particle diameter: 102 nm)
Grinding agent: 35 parts
(Precipitated calcium carbonate, number average particle diameter: 0.4 μm)
Binder: 30 parts
(Resin 1; amorphous polyester: composition (mol %) [polyoxypropylene (2.2)-2,2-bis(4-hydroxyphenyl)propane:isophthalic acid:terephthalic acid=100:50:50], softening point (Tm): 122° C., glass transition temperature (Tg): 70° C., SP value: 22.6 (J/cm³)^{0.5})

The above-mentioned materials were mixed using a Henschel mixer (FM-75 type, manufactured by Nippon Coke & Engineering Co., Ltd.) at a rotation speed of 20 s⁻¹ for a rotation time of 5 minutes and were then kneaded with a biaxial kneader (PCM-30 type, manufactured by Ikegai Corporation) at 120° C. The resulting kneaded product was cooled and was roughly pulverized with a pin mill to a particle diameter of 100 μm or less to obtain a roughly pulverized product of pigment dispersion A-1. The melt viscosity of Resin 1 at 120° C. was 2080 Pa·sec. The pigment in the obtained pigment dispersion A-1 had a number average particle diameter of 55 nm.

Manufacturing of Pigment Dispersion A-2

A roughly pulverized product of pigment dispersion A-2 was prepared as in pigment dispersion A-1 except that the binder was changed to the following Resin 2. The melt viscosity of Resin 2 at 120° C. was 1490 Pa·sec. The pigment in the resulting pigment dispersion A-2 had a number average particle diameter of 57 nm.

### Resin 2:

Styrene-butyl acrylate copolymer: composition (mol %) [styrene:butyl acrylate=72.5:27.5], softening point (Tm): 118° C., glass transition temperature (Tg): 55° C., SP value: 21.1 (J/cm³)^{0.5}

Manufacturing of Pigment Dispersions A-3 to A-35

Pigment dispersions A-3 to A-35 were prepared as in pigment dispersion A-1 except that the binder, the grinding agent, and the pigment shown in the following Table 1 were used and kneaded under conditions shown in Table 2. The number average particle diameters of the pigments in the resulting pigment dispersions A-3 to A-35 are shown in Table 2.

Incidentally, Resins 3 and 5 to 9 were amorphous polyesters having physical properties shown in Table 1, and Resin 4 was a styrene acrylic resin having physical properties shown in Table 1.

In addition, the crystalline resin in the pigment dispersion A-18 was the following resin.

Crystalline polyester: composition (mol %) [1,6-hexanediol:dodecanedioic acid=100:100], melting point: 72° C.

Furthermore, the synthetic wax in the pigment dispersion A-19 was the following wax.

Synthetic wax (FNP0090, manufactured by Nippon Seiro Co., Ltd., melting point: 90° C.)

In addition, in manufacturing of pigment dispersion A-5, a monoaxial extruder kneader was used instead of the biaxial extruder kneader.

Manufacturing of Pigment Dispersion A-36

A roughly pulverized product of pigment dispersion A-36 was prepared as in pigment dispersion A-1 except that the binder was changed to a polyester thermoplastic elastomer (block copolymer of polybutylene terephthalate and polytetramethylene ether glycol, melting point: 163° C.)] and that the kneading temperature was 200° C. The melt viscosity of the polyester thermoplastic elastomer at 200° C. was 5040 Pa·sec. The number average particle diameter of the pigment in the resulting pigment dispersion A-36 was 65 nm.

TABLE 1

| | Binder | | | | | Grinding agent | | |
|---|---|---|---|---|---|---|---|---|
| Pigment | | Tg | Tm | Melting | SP value | | Particle | Pigment |
| dispersion | Type | (° C.) | (° C.) | point (° C.) | ((J/cm³)^{0.5}) | Type | size (μm) | Type |
| A-1 | Resin 1 | 70 | 122 | — | 22.6 | Calcium carbonate | 0.4 | PB 15:3 |
| A-2 | Resin 2 | 55 | 118 | — | 21.1 | Calcium carbonate | 0.4 | PB 15:3 |
| A-3 | Resin 1 | 70 | 122 | — | 22.6 | Calcium carbonate | 0.4 | PB 15:3 |
| A-4 | Resin 1 | 70 | 122 | — | 22.6 | Kaolinite | 0.4 | PB 15:3 |
| A-5 | Resin 1 | 70 | 122 | — | 22.6 | Talc | 1.0 | PB 15:3 |
| A-6 | Resin 1 | 70 | 122 | — | 22.6 | Barium sulfate | 0.5 | PB 15:3 |
| A-7 | Resin 1 | 70 | 122 | — | 22.6 | Calcium carbonate | 0.2 | PB 15:3 |
| A-8 | Resin 1 | 70 | 122 | — | 22.6 | Calcium carbonate | 1.0 | PB 15:3 |
| A-9 | Resin 3 | 60 | 138 | — | 24.0 | Calcium carbonate | 0.4 | PB 15:3 |
| A-10 | Resin 4 | 28 | 81 | — | 20.7 | Calcium carbonate | 0.4 | PB 15:3 |
| A-11 | Resin 5 | 52 | 101 | — | 22.2 | Calcium carbonate | 0.4 | PB 15:3 |
| A-12 | Resin 6 | 58 | 148 | — | 22.1 | Calcium carbonate | 0.4 | PB 15:3 |
| A-13 | Resin 1:Resin 2 = 50 mass %:50 mass % | | | | | Calcium carbonate | 0.4 | PB 15:3 |
| A-14 | Resin 1:Resin 2 = 40 mass %:60 mass % | | | | | Calcium carbonate | 0.4 | PB 15:3 |
| A-15 | Resin 7 | 79 | 198 | — | 23.5 | Calcium carbonate | 0.4 | PB 15:3 |
| A-16 | Resin 8 | 31 | 73 | — | 22.6 | Calcium carbonate | 0.4 | PB 15:3 |
| A-17 | Resin 9 | 81 | 135 | — | 22.6 | Calcium carbonate | 0.4 | PB 15:3 |
| A-18 | Resin 1:Crystalline resin = | | | | | Calcium carbonate | 0.4 | PB 15:3 |
| | 85 mass %:15 mass % | | | | | | | |
| A-19 | Resin 1:Resin 2:Synthetic wax = | | | | | Calcium carbonate | 0.4 | PB 15:3 |
| | 20 mass %:40 mass %:40 mass % | | | | | | | |
| A-20 | Resin 1 | 70 | 122 | — | 22.6 | Calcium carbonate | 0.4 | PB 15:3 |
| A-21 | Resin 1 | 70 | 122 | — | 22.6 | Calcium carbonate | 0.4 | PB 15:3 |
| A-22 | Resin 1 | 70 | 122 | — | 22.6 | Calcium carbonate | 0.4 | PB 15:3 |
| A-23 | Resin 1 | 70 | 122 | — | 22.6 | Calcium carbonate | 0.4 | PB 15:3 |
| A-24 | Resin 1 | 70 | 122 | — | 22.6 | Calcium carbonate | 0.1 | PB 15:3 |
| A-25 | Resin 1 | 70 | 122 | — | 22.6 | Calcium carbonate | 5.0 | PB 15:3 |
| A-26 | Resin 1 | 70 | 122 | — | 22.6 | Calcium carbonate | 0.4 | PR 122 |
| A-27 | Resin 1 | 70 | 122 | — | 22.6 | Calcium carbonate | 0.4 | PY 180 |
| A-28 | Resin 1 | 70 | 122 | — | 22.6 | Sodium chloride | 10.0 | PB 15:3 |
| A-29 | Resin 1 | 70 | 122 | — | 22.6 | Calcium carbonate | 0.4 | PB 15:3 |
| A-30 | Resin 1 | 70 | 122 | — | 22.6 | Calcium carbonate | 0.4 | PB 15:3 |
| A-31 | Resin 1 | 70 | 122 | — | 22.6 | Calcium carbonate | 0.4 | PB 15:3 |
| A-32 | Resin 1 | 70 | 122 | — | 22.6 | Calcium carbonate | 0.4 | PB 15:3 |
| A-33 | Resin 1 | 70 | 122 | — | 22.6 | Calcium carbonate | 0.04 | PB 15:3 |
| A-34 | Resin 1 | 70 | 122 | — | 22.6 | Calcium carbonate | 6.0 | PB 15:3 |
| A-35 | Resin 1 | 70 | 122 | — | 22.6 | Calcium carbonate | 0.4 | PB 15:3 |
| A-36 | Elastomer | — | — | 163 | — | Calcium carbonate | 0.4 | PB 15:3 |

TABLE 2

| | | | | | | | Number average | |
|---|---|---|---|---|---|---|---|---|
| | | | | | | | particle size | |
| | | Binder | | Grinding | | | of pigment | |
| | | Melt viscosity at | | agent | Pigment | Pigment/ | Raw | After |
| Pigment | Kneading | kneading temp. | Content | Content | Content | Grinding agent | material | pulverization |
| dispersion | temp. (° C.) | (Pa · sec) | (mass %) | (mass %) | (mass %) | Mass ratio | (nm) | (nm) |
| A-1 | 120 | 2080 | 30 | 35 | 35 | 1.0 | 102 | 55 |
| A-2 | 120 | 1490 | 30 | 35 | 35 | 1.0 | 102 | 57 |
| A-3 | 120 | 2080 | 30 | 35 | 35 | 1.0 | 102 | 60 |
| A-4 | 120 | 2080 | 30 | 35 | 35 | 1.0 | 102 | 59 |
| A-5 | 120 | 2080 | 30 | 35 | 35 | 1.0 | 102 | 60 |
| A-6 | 120 | 2080 | 30 | 35 | 35 | 1.0 | 102 | 59 |
| A-7 | 120 | 2080 | 30 | 35 | 35 | 1.0 | 102 | 62 |
| A-8 | 120 | 2080 | 30 | 35 | 35 | 1.0 | 102 | 56 |
| A-9 | 145 | 5050 | 30 | 35 | 35 | 1.0 | 102 | 52 |
| A-10 | 85 | 1450 | 30 | 35 | 35 | 1.0 | 102 | 57 |
| A-11 | 100 | 1900 | 30 | 35 | 35 | 1.0 | 102 | 59 |
| A-12 | 146 | 5200 | 30 | 35 | 35 | 1.0 | 102 | 51 |
| A-13 | 120 | 1950 | 30 | 35 | 35 | 1.0 | 102 | 56 |
| A-14 | 120 | 1620 | 30 | 35 | 35 | 1.0 | 102 | 56 |
| A-15 | 200 | 5990 | 30 | 35 | 35 | 1.0 | 102 | 65 |
| A-16 | 70 | 1510 | 30 | 35 | 35 | 1.0 | 102 | 58 |
| A-17 | 130 | 2300 | 30 | 35 | 35 | 1.0 | 102 | 55 |
| A-18 | 120 | 1280 | 30 | 35 | 35 | 1.0 | 102 | 50 |
| A-19 | 120 | 1550 | 30 | 35 | 35 | 1.0 | 102 | 58 |
| A-20 | 120 | 2080 | 30 | 58.3 | 11.7 | 0.2 | 102 | 52 |
| A-21 | 120 | 2080 | 30 | 28 | 42 | 1.5 | 102 | 63 |
| A-22 | 120 | 2080 | 5 | 47.5 | 47.5 | 1.0 | 102 | 65 |
| A-23 | 120 | 2080 | 50 | 25 | 25 | 1.0 | 102 | 61 |
| A-24 | 120 | 2080 | 30 | 35 | 35 | 1.0 | 102 | 64 |
| A-25 | 120 | 2080 | 30 | 35 | 35 | 1.0 | 102 | 65 |
| A-26 | 120 | 2080 | 30 | 35 | 35 | 1.0 | 80 | 40 |
| A-27 | 120 | 2080 | 30 | 35 | 35 | 1.0 | 150 | 40 |
| A-28 | 120 | 2080 | 30 | 35 | 35 | 1.0 | 150 | 58 |
| A-29 | 120 | 2080 | 30 | 61.4 | 8.6 | 0.14 | 102 | 52 |
| A-30 | 120 | 2080 | 30 | 26.9 | 43.1 | 1.6 | 102 | 89 |
| A-31 | 120 | 2080 | 4 | 48 | 48 | 1.0 | 102 | 75 |
| A-32 | 120 | 2080 | 55 | 22.5 | 22.5 | 1.0 | 102 | 78 |
| A-33 | 120 | 2080 | 30 | 35 | 35 | 1.0 | 102 | 92 |
| A-34 | 120 | 2080 | 30 | 35 | 35 | 1.0 | 102 | 63 |
| A-35 | 113 | 6500 | 30 | 35 | 35 | 1.0 | 102 | 81 |
| A-36 | 200 | 5040 | 30 | 35 | 35 | 0.0 | 102 | 65 |

Manufacturing Example of Toner A-1

Amorphous polyester: 77.7 parts
(Composition (mol %) [polyoxypropylene (2.2)-2,2-bis(4-hydroxyphenyl)propane:isophthalic acid:terephthalic acid=100:50:50], softening point (Tm): 122° C., glass transition temperature (Tg): 70° C., SP value: 22.6 (J/cm³)^{0.5})
Pigment dispersion A-1: 14.3 parts
Hydrocarbon wax (peak temperature of maximum endothermic peak: 90° C.): 8.0 parts

The above-mentioned materials were mixed using a Henschel mixer (FM-75 type, manufactured by Nippon Coke & Engineering Co., Ltd.) at a rotation speed of 20 s⁻¹ for a rotation time of 5 minutes and were then melted and kneaded with a biaxial kneader (PCM-30 type, manufactured by Ikegai Corporation). The resulting kneaded product was cooled and was roughly pulverized with a pin mill to a particle diameter of 100 μm or less to obtain a roughly pulverized product. The resulting roughly pulverized product was finely pulverized with a mechanical pulverizer (T-250, manufactured by Freund-Turbo Corporation) to a target particle diameter by adjusting the rotation speed and the number of passes. Furthermore, classification was performed using a rotary classifier (200TSP, manufactured by Hosokawa Micron Corporation) to obtain toner particles having a weight average particle diameter of 6.5 μm. As the operational conditions of the rotary classifier (200TSP, manufactured by Hosokawa Micron Corporation) for classification, the rotation speed was adjusted so that the target particle diameter and the particle size distribution were obtained.

Silica microparticles (BET specific surface area: 200 m²/g, 1.8 parts) hydrophobized with silicone oil were added to the resulting toner particles (100 parts), and the mixture was mixed with a Henschel mixer (FM-75 type, manufactured by Nippon Coke & Engineering Co., Ltd.) at a rotation speed of 30 s⁻¹ for a rotation time of 10 minutes to obtain toner A-1.

Manufacturing Examples of Tones A-2 to A-20 and A-24 to A-40

Toners A-2 to A-20 and A-24 to A-40 were manufactured as in toner 1 except that the materials and conditions were changed to those shown in Table 3.

Incidentally, in toner A-11, a resin having an SP value of 23.9 (J/cm³)^{0.5} was used as the amorphous polyester.

Toners A-32 to A-39 manufactured using the pigment dispersions A-28 to A-35 are described as Comparative Examples.

Manufacturing Example of Toner A-21

Pigment dispersion A-1: 160 parts
Organic solvent (toluene): 150 parts
Glass beads (diameter: 1 mm): 130 parts

The above-mentioned materials were mixed and were dispersed with an attritor (manufactured by Nippon Coke & Engineering Co., Ltd.) for 3 hours to obtain a dispersion liquid.

Subsequently,

Amorphous polyester used in the manufacturing of toner A-1: 75.7 parts
The above dispersion liquid: 50 parts
Hydrocarbon wax (peak temperature of maximum endothermic peak: 90° C.): 10 parts
Toluene: 350 parts
were mixed, and the temperature thereof was raised to 80° C. while stirring to dissolve and disperse the materials to produce a resin solution.

Subsequently, trisodium phosphate dodecahydrate (manufactured by FUJIFILM Wako Pure Chemical Corporation, 11.7 parts) and deionized water (1200 parts) were added to a beaker set to a water bath to dissolve the trisodium phosphate dodecahydrate. Subsequently, the temperature of the water bath was raised to 60° C. After reached 60° C., an aqueous solution prepared by dissolving 5.15 parts of calcium chloride (manufactured by Kishida Chemical Co., Ltd.) in 100 parts of deionized water was added thereto. After the addition, stirring was performed for 30 minutes to obtain an aqueous medium containing tricalcium phosphate.

Separately, the aqueous medium (600 parts) was heated to 80° C. while stirring with Crea Mix (manufactured by M Technique Co., Ltd.). A resin solution was added to this aqueous medium, followed by stirring at 10000 rpm for 10 minutes for granulation to obtain a dispersion liquid of the droplet particles. Stirring using a stirring blade was continued for 5 hours while maintaining the temperature at 80° C. to remove toluene contained in the droplet particles. Subsequently, the droplet particles were cooled to 25° C. over 10 minutes to obtain a dispersion liquid of the toner particles.

Dilute hydrochloric acid was added to the dispersion liquid of the toner particles while stirring. The mixture was stirred at pH 1.5 for 2 hours to dissolve the tricalcium phosphate, and solid-liquid separation with a filter was performed to obtain resin particles.

The resin particles were put into water, followed by stirring to obtain a dispersion liquid again. The dispersion liquid was then subjected to solid-liquid separation with a filter. This procedure was repeated until the tricalcium phosphate was sufficiently removed, and the resulting particles were sufficiently dried with a drier to obtain toner particles.

The resulting toner particles were subjected to external addition in the same manner as the toner A-1 to obtain toner A-21.

Manufacturing Example of Toner A-22

Styrene: 47.6 parts
n-Butyl acrylate: 15.1 parts
Pigment dispersion A-2: 14.3 parts
Hydrocarbon wax (peak temperature of maximum endothermic peak: 90° C.): 20.0 parts
Amorphous polyester used in manufacturing of toner A-1: 3.0 parts

The above-mentioned materials were mixed and were put into an attritor (manufactured by Nippon Coke & Engineering Co., Ltd.) and were dispersed using zirconia beads having a diameter of 5 mm at a condition of 200 rpm for 2 hours to obtain a polymerizable monomer composition.

Separately, deionized water (735.0 parts) and trisodium phosphate (dodecahydrate) (16.0 parts) were added to a container equipped with a high speed stirring device homomixer (manufactured by PRIMIX Corporation) and a thermometer, and the temperature was raised to 60° C. while stirring at 12000 rpm. A calcium chloride aqueous solution prepared by dissolving calcium chloride (dihydrate) (9.0 parts) in deionized water (65.0 parts) was then put into the container, followed by stirring at 12000 rpm for 30 minutes while maintaining the temperature at 60° C. The pH was adjusted to 6.0 by adding 10% hydrochloric acid thereto to obtain an aqueous medium containing a dispersion stabilizer.

Subsequently, the polymerizable monomer composition was transferred to a container equipped with a stirrer and a thermometer and was heated to 60° C. while stirring at 100 rpm, and t-butyl peroxypivalate (Perbutyl PV, manufactured by NOF Corporation, 8.0 parts) was added thereto as a polymerization initiator, followed by stirring at 100 rpm for 5 minutes while maintaining 60° C. Subsequently, a polymerizable monomer composition containing a polymerization initiator was put into the aqueous medium that was being stirred with the high speed stirring device at 12000 rpm. Stirring with the high speed stirring device was continued at 12000 rpm for 20 minutes while maintaining 60° C. to perform granulation to obtain a dispersion liquid in which the droplet particles were dispersed. The dispersion liquid was transferred to a reaction container equipped with a reflux condenser tube, a stirrer, a thermometer, and a nitrogen introduction pipe and was heated to 70° C. in a nitrogen atmosphere, while stirring at 150 rpm. The polymerizable monomer contained in the droplet particles was polymerized at 150 rpm for 10 hours while maintaining 70° C. Subsequently, the reflux condenser tube was removed from the reaction container, and the reaction solution was heated to 95° C. and was stirred at 150 rpm for 5 hours while maintaining 95° C. to obtain a toner-particle dispersion liquid.

The resulting toner-particle dispersion liquid was cooled to 20° C. while stirring at 150 rpm, and dilute hydrochloric acid was added thereto until the pH reached 1.5 while continuing the stirring to dissolve the dispersion stabilizer. The solid content was collected by filtration and was sufficiently washed with deionized water and was then vacuum dried at 40° C. for 24 hours to obtain toner particles.

The resulting toner particles were subjected to external addition in the same manner as the toner A-1 to obtain toner A-22.

Manufacturing Example of Toner A-23

Manufacturing of dispersion liquid of resin microparticles Tetrahydrofuran (manufactured by FUJIFILM Wako Pure Chemical Corporation): 200 parts

Amorphous polyester used in manufacturing of toner A-1: 120 parts
Anionic surfactant (manufactured by DKS Co., Ltd.: NEOGEN RK): 0.6 parts

The above-mentioned materials were mixed and were then stirred for 12 hours to dissolve the resin in tetrahydrofuran.

Subsequently, N,N-dimethylaminoethanol (2.7 parts) was added to the above-obtained solution, followed by stirring using an ultra-high speed stirring device T.K. ROBOMIX (manufactured by PRIMIX Corporation) at 4000 rpm.

Furthermore, deionized water (359.4 parts) was added thereto at a rate of 1 g/min to precipitate resin microparticles. Subsequently, tetrahydrofuran was removed using an evaporator to obtain a dispersion liquid of amorphous resin microparticles.

Manufacturing of Dispersion Liquid of Pigment Dispersion Microparticles

Tetrahydrofuran (manufactured by FUJIFILM Wako Pure Chemical Corporation): 200 parts
Pigment dispersion A-1: 42.9 parts
Anionic surfactant (NEOGEN RK, manufactured by DKS Co., Ltd.): 1.5 parts

The above-mentioned materials were mixed and were then stirred for 12 hours to dissolve the binder in the pigment dispersion in tetrahydrofuran.

Subsequently, N,N-dimethylaminoethanol (0.3 parts) and deionized water (255.6 parts) were added to above-obtained solution, followed by stirring using an ultra-high speed stirring device T.K. ROBOMIX (manufactured by PRIMIX Corporation) at 4000 rpm.

Furthermore, dispersion was performed for about 1 hour using a high pressure impact disperser Nano-Mizer (manufactured by Yoshida Kikai Co., Ltd.). Subsequently, tetrahydrofuran was removed using an evaporator to obtain a dispersion liquid of the pigment dispersion.

Manufacturing of Dispersion of Release Agent Microparticles

Hydrocarbon wax (peak temperature of maximum endothermic peak 90° C.): 20.0 parts
Anionic surfactant (NEOGEN RK, manufactured by DKS Co., Ltd.): 1.0 parts
Deionized water: 79.0 parts

The above materials were put into a mixing container equipped with a stirrer and were then heated to 90° C. and were stirred with a shear stirring unit of a rotor outer diameter of 3 cm and a clearance of 0.3 mm under conditions of a rotor rotation speed of 19000 rpm and a screen rotation speed of 19000 rpm while circulating in CLEARMIX W-MOTION (manufactured by M Technique Co., Ltd.) to perform dispersion treatment for 60 minutes.

Subsequently, a dispersion liquid of release agent microparticles was obtained by cooling to 40° C. under cooling treatment conditions of a rotor rotation speed of 1000 rpm, a screen rotation speed of 0 rpm, and a cooling rate of 10° C./min.

Aggregation

Dispersion liquid of resin microparticles: 310.8 parts
Dispersion liquid of pigment dispersion microparticles: 100 parts
Dispersion liquid of release agent microparticles: 50 parts
Deionized water: 400 parts

The above-mentioned materials were put into a round stainless beaker and were mixed, and an aqueous solution in which 2 parts of magnesium sulfate was dissolved in 98 parts of deionized water was then added to the beaker to perform dispersion using a homogenizer (manufactured by IKA: ULTRA-TURRAX T50) at 5000 rpm for 10 minutes.

Subsequently, the mixture solution was heated to 58° C. while appropriately controlling the rotation speed such that the mixture solution was stirred using a stirring blade in a water bath for heating. The temperature of 58° C. was maintained for 1 hour to obtain aggregate particles.

### Fusion

An aqueous solution in which 20 parts of trisodium citrate was dissolved in 380 parts of deionized water was further added to the dispersion liquid containing the aggregate particles, followed by heating to 95° C.

The aggregate particles were maintained at 95° C. for 2 hours for fusion of the aggregate particles, followed by cooling to 25° C. while continuing the stirring to obtain a toner-particle dispersion liquid.

Subsequently, filtration and solid-liquid separation were performed, and the residue was sufficiently washed with deionized water and was dried with a vacuum dryer to obtain toner particles.

The resulting toner particles were subjected to external addition in the same manner as the toner A-1 to obtain toner A-23.

TABLE 3

| | | | Resin for toner (Resin A) | | | | | | |
|---|---|---|---|---|---|---|---|---|---|
| | | | | | Absolute value of | | | | |
| | | | | | difference in SP | | | | |
| | | | | | value with | | | | |
| | Pigment | | | | amorphous | | | Toner particles | |
| | dispersion | | | | resin binder | | Wax | | Weight |
| | | Addition | | | in pigment | Addition | Addition | | average |
| Toner | | amount | | SP value | dispersion | amount | amount | Manufacturing | particle |
| No. | No. | (parts) | Type | ((J/cm³)^{0.5}) | ((J/cm³)^{0.5}) | (parts) | (parts) | method | size (μm) |
| A-1 | A-1 | 14.3 | Amorphous PES | 22.6 | 0 | 77.7 | 8 | Kneading crushing | 6.5 |
| A-2 | A-2 | 14.3 | Amorphous PES | 22.6 | 1.5 | 77.7 | 8 | Kneading crushing | 6.5 |
| A-3 | A-3 | 14.3 | Amorphous PES | 22.6 | 0 | 77.7 | 8 | Kneading crushing | 6.5 |
| A-4 | A-4 | 14.3 | Amorphous PES | 22.6 | 0 | 77.7 | 8 | Kneading crushing | 6.5 |
| A-5 | A-5 | 14.3 | Amorphous PES | 22.6 | 0 | 77.7 | 8 | Kneading crushing | 6.5 |
| A-6 | A-6 | 14.3 | Amorphous PES | 22.6 | 0 | 77.7 | 8 | Kneading crushing | 6.5 |
| A-7 | A-7 | 14.3 | Amorphous PES | 22.6 | 0 | 77.7 | 8 | Kneading crushing | 6.5 |
| A-8 | A-8 | 14.3 | Amorphous PES | 22.6 | 0 | 77.7 | 8 | Kneading crushing | 6.5 |
| A-9 | A-9 | 14.3 | Amorphous PES | 22.6 | 1.4 | 77.7 | 8 | Kneading crushing | 6.5 |
| A-10 | A-10 | 14.3 | Amorphous PES | 22.6 | 1.9 | 77.7 | 8 | Kneading crushing | 6.5 |
| A-11 | A-10 | 14.3 | Amorphous PES | 23.9 | 3.2 | 77.7 | 8 | Kneading crushing | 6.5 |
| A-12 | A-11 | 14.3 | Amorphous PES | 22.6 | 0.4 | 77.7 | 8 | Kneading crushing | 6.5 |
| A-13 | A-12 | 14.3 | Amorphous PES | 22.6 | 0.5 | 77.7 | 8 | Kneading crushing | 6.5 |
| A-14 | A-13 | 14.3 | Amorphous PES | 22.6 | — | 77.7 | 8 | Kneading crushing | 6.5 |
| A-15 | A-14 | 14.3 | Amorphous PES | 22.6 | — | 77.7 | 8 | Kneading crushing | 6.5 |
| A-16 | A-15 | 14.3 | Amorphous PES | 22.6 | 0.9 | 77.7 | 8 | Kneading crushing | 6.5 |
| A-17 | A-16 | 14.3 | Amorphous PES | 22.6 | 0 | 77.7 | 8 | Kneading crushing | 6.5 |
| A-18 | A-17 | 14.3 | Amorphous PES | 22.6 | 0 | 77.7 | 8 | Kneading crushing | 6.5 |
| A-19 | A-18 | 14.3 | Amorphous PES | 22.6 | — | 77.7 | 8 | Kneading crushing | 6.5 |
| A-20 | A-19 | 14.3 | Amorphous PES | 22.6 | — | 77.7 | 8 | Kneading crushing | 6.5 |
| A-21 | A-1 | 14.3 | Amorphous PES | 22.6 | 0 | 75.7 | 10 | Dissolution | 6.4 |
| | | | | | | | | suspension | |
| A-22 | A-2 | 14.3 | Styrene | 21.1 | 0 | 62.7 | 20 | Suspension | 6.5 |
| | | | acrylic resin | | | | | polymerization | |
| A-23 | A-1 | 14.3 | Amorphous PES | 22.6 | 0 | 75.7 | 10 | Emulsification | 6.3 |
| | | | | | | | | aggregation | |
| A-24 | A-20 | 25.7 | Amorphous PES | 22.6 | 0 | 66.3 | 8 | Kneading crushing | 6.5 |
| A-25 | A-21 | 11.9 | Amorphous PES | 22.6 | 0 | 80.1 | 8 | Kneading crushing | 6.5 |
| A-26 | A-22 | 10.5 | Amorphous PES | 22.6 | 0 | 81.5 | 8 | Kneading crushing | 6.5 |
| A-27 | A-23 | 20.0 | Amorphous PES | 22.6 | 0 | 72.0 | 8 | Kneading crushing | 6.5 |
| A-28 | A-24 | 14.3 | Amorphous PES | 22.6 | 0 | 77.7 | 8 | Kneading crushing | 6.5 |
| A-29 | A-25 | 14.3 | Amorphous PES | 22.6 | 0 | 77.7 | 8 | Kneading crushing | 6.5 |
| A-30 | A-26 | 14.3 | Amorphous PES | 22.6 | 0 | 77.7 | 8 | Kneading crushing | 6.5 |
| A-31 | A-27 | 14.3 | Amorphous PES | 22.6 | 0 | 77.7 | 8 | Kneading crushing | 6.5 |
| A-32 | A-28 | 14.3 | Amorphous PES | 22.6 | 0 | 77.7 | 8 | Kneading crushing | 6.5 |
| A-33 | A-29 | 28.1 | Amorphous PES | 22.6 | 0 | 63.9 | 8 | Kneading crushing | 6.5 |
| A-34 | A-30 | 11.6 | Amorphous PES | 22.6 | 0 | 80.4 | 8 | Kneading crushing | 6.5 |
| A-35 | A-31 | 10.4 | Amorphous PES | 22.6 | 0 | 81.6 | 8 | Kneading crushing | 6.5 |
| A-36 | A-32 | 22.2 | Amorphous PES | 22.6 | 0 | 69.8 | 8 | Kneading crushing | 6.5 |
| A-37 | A-33 | 14.3 | Amorphous PES | 22.6 | 0 | 77.7 | 8 | Kneading crushing | 6.5 |
| A-38 | A-34 | 14.3 | Amorphous PES | 22.6 | 0 | 77.7 | 8 | Kneading crushing | 6.5 |
| A-39 | A-35 | 14.3 | Amorphous PES | 22.6 | 0 | 77.7 | 8 | Kneading crushing | 6.5 |
| A-40 | A-36 | 14.3 | Amorphous PES | 22.6 | — | 77.7 | 8 | Kneading crushing | 6.5 |

Manufacturing Example of Two-Component Developer A-1

A magnetic carrier having a coat layer of a copolymer of cyclohexyl methacrylate, methyl methacrylate, and methyl methacrylate macromonomer formed on the surface of Mn—Mg—Sr ferrite carrier core and having a 50% particle diameter (D50) of 38.2 μm on a volume distribution basis was prepared.

This magnetic carrier (92.0 parts) and toner A-1 (8.0 parts) were mixed with a V-shape rotating mixer (V-20, manufactured by Seishin Enterprise Co., Ltd.) to obtain two-component developer A-1.

Manufacturing Examples of Two-Component Developers A-2 to A-40

Two-component developers A-2 to A-40 were manufactured as in the Manufacturing Example of two-component developer A-1 except that toner A-1 was changed to toners A-2 to A-40, respectively.

### Evaluation of Storage Stability

Each toner was left to stand in a thermo-hygrostat for 3 days and was sieved with a sieve of an aperture of 75 μm at a shaking amplitude of 1 mm for 300 seconds, and the amount of the toner remaining on the sieve was evaluated by the following criteria. The results are shown in Table 4.

Evaluation Criteria

A: When a toner is left to stand in a thermo-hygrostat of a temperature of 55° C. and a humidity of 10% RH for 3 days and is then sieved, the amount of the toner remaining on the sieve is 10 mass % or less;
B: When a toner is left to stand in a thermo-hygrostat of a temperature of 55° C. and a humidity of 10% RH for 3 days and is then sieved, the amount of the toner remaining on the sieve is 10 mass % or more, but when the toner is left to stand in a thermo-hygrostat of a temperature of 50° C. and a humidity of 10% RH for 3 days and is then sieved, the amount of the toner remaining on the sieve is 10 mass % or less; and
C: When the toner is left to stand in a thermo-hygrostat of a temperature of 50° C. and a humidity of 10% RH for 3 days and is then sieved, the amount of the toner remaining on the sieve is 10 mass % or more.

### Method for Evaluating Coloring Power of Toner

As the image forming apparatus, a modified apparatus of a full-color copier image RUNNER ADVANCE C5255 manufactured by CANON KABUSHIKI KAISHA was used, and each two-component developer was put into the developing unit of the cyan station and was evaluated.

The evaluation environment was a normal temperature and normal humidity environment (23° C., 50% RH), and as the evaluation paper, plain copy paper GFC-081 (A4, basis weight: 81.4 g/m², available from Canon Marketing Japan Inc.) was used.

First, in the evaluation environment, the relationship between the image density and the toner bearing amount on paper was investigated by changing the toner bearing amount on the paper.

Subsequently, the image density of the FFH image (solid portion) was adjusted to 1.40, and the toner bearing amount when the image density reached 1.40 was determined.

The FFH image was the value displaying 256 tones in hexadecimal, and OOH was defined as the 1st tone (white portion), and FFH was defined as the 256th tone (solid portion).

The image density was measured using an X-Rite color reflection densitometer (500 series: manufactured by X-Rite Inc.).

The coloring power of a toner was evaluated from the toner bearing amount (mg/cm²) by the following criteria. The evaluation results are shown in Table 4.

Evaluation Criteria

A: less than 0.35
B: 0.35 or more and less than 0.50
C: 0.50 or more and less than 0.65
D: 0.65 or more

### Evaluation of Charge Retention Ability

The triboelectric charging amount of a toner was measured with Espart Analyzer of Hosokawa Micron Corporation using each two-component developer. The chargeability of the toner was evaluated by the following criteria.

The triboelectric charging amount of an initial toner was measured, and the triboelectric charging amount was measured again using a two-component developer left to stand in a thermo-hygrostat (temperature: 30° C., humidity: 80% RH) for one week.

The retention rate of the triboelectric charging amount was calculated by substituting the measurement result for the following equation and was evaluated by the following criteria. The evaluation results are shown in Table 4.

Triboelectric charging amount retention rate (%) of toner=[triboelectric charging amount of toner after one week]/[triboelectric charging amount of initial toner]×100

Evaluation Criteria

A: The triboelectric charging amount retention rate is 80% or more,
B: The triboelectric charging amount retention rate is 60% or more and less than 80%, and
C: The triboelectric charging amount retention rate is less than 60%.

TABLE 4

| | Two- | | | Charge |
|---|---|---|---|---|
| | component | Storage | Coloring | retention |
| Toner | developer | stability | power | ability |
| A-1 | A-1 | A | A | A |
| A-2 | A-2 | A | B | A |
| A-3 | A-3 | A | B | A |
| A-4 | A-4 | A | B | B |
| A-5 | A-5 | A | B | B |
| A-6 | A-6 | A | B | A |
| A-7 | A-7 | A | C | A |
| A-8 | A-8 | A | A | B |
| A-9 | A-9 | A | A | B |
| A-10 | A-10 | A | B | A |
| A-11 | A-11 | A | B | B |
| A-12 | A-12 | A | B | A |
| A-13 | A-13 | A | A | A |
| A-14 | A-14 | A | A | A |
| A-15 | A-15 | A | A | A |
| A-16 | A-16 | A | C | A |
| A-17 | A-17 | B | B | B |
| A-18 | A-18 | A | A | A |
| A-19 | A-19 | A | A | A |
| A-20 | A-20 | A | B | B |
| A-21 | A-21 | A | A | B |
| A-22 | A-22 | A | B | A |
| A-23 | A-23 | A | A | B |
| A-24 | A-24 | A | B | B |
| A-25 | A-25 | A | B | A |
| A-26 | A-26 | A | B | A |
| A-27 | A-27 | A | C | A |
| A-28 | A-28 | A | C | A |
| A-29 | A-29 | A | C | B |
| A-30 | A-30 | A | B | A |
| A-31 | A-31 | A | B | A |
| A-32 | A-32 | C | B | C |
| A-33 | A-33 | A | D | C |
| A-34 | A-34 | A | D | A |
| A-35 | A-35 | A | D | A |
| A-36 | A-36 | A | D | A |
| A-37 | A-37 | A | D | A |
| A-38 | A-38 | A | D | C |
| A-39 | A-39 | A | D | A |
| A-40 | A-40 | A | C | A |

Since toner A-32 was a toner manufactured by using a water-soluble sodium chloride without performing filtration washing and drying process, sodium chloride was contained in the toner, resulting in unacceptable storage stability and charge retention ability.

Since toner A-33 was manufactured under conditions where the amount of the grinding agent relative to the pigment was too high, resulting in that the charge retention ability and the coloring power were unacceptably low.

Since toner A-34 was manufactured under conditions where the amount of the grinding agent relative to the pigment was too small, sufficient crushing was not performed, and the pigment particle diameter was large, resulting in unacceptable coloring power.

Since toner A-35 was manufactured under conditions where the amount of the binder in the pigment dispersion was too small, the pigment and the grinding agent were not sufficiently mixed, and the pigment particle diameter was large, resulting in unacceptable coloring power.

Since toner A-36 was manufactured under conditions where the amount of the binder in the pigment dispersion was too large, the degree of crushing of the toner by the grinding agent was low, and the pigment particle diameter was large, resulting in unacceptable coloring power.

Since toner A-37 was manufactured under conditions where the particle diameter of the grinding agent was too small, the degree of crushing of the toner by the grinding agent was low, and the pigment particle diameter was large, resulting in unacceptable coloring power.

Since toner A-38 was manufactured under conditions where the particle diameter of the grinding agent was too large, the charge retention ability and the coloring power were low, resulting in unacceptable results.

In toner A-39, the viscosity of the binder at the time of crushing the pigment was too high, the pigment and the grinding agent were not sufficiently mixed, and the pigment particle diameter was too large, resulting in unacceptable coloring power.

Manufacturing of Pigment Dispersion B-1

Pigment: 35 parts
(cyan pigment: Pigment Blue 15:3, volume average particle diameter: 102 nm)
Grinding agent: 35 parts
(precipitated calcium carbonate, number average particle diameter: 0.4 μm)
Binder B-1: 30 parts
(synthetic wax, FNP0090, manufactured by Nippon Seiro Co., Ltd., melting point: 90° C., number average molecular weight: 578)

The above-mentioned materials were mixed using a Henschel mixer (FM-75 type, manufactured by Nippon Coke & Engineering Co., Ltd.) at a rotation speed of 20 s⁻¹ for a rotation time of 5 minutes and were then kneaded with a biaxial kneader (PCM-30 type, manufactured by Ikegai Corporation) at 100° C. The resulting kneaded product was cooled and was roughly pulverized with a pin mill to a volume average particle diameter of 100 μm or less to obtain a roughly pulverized product of pigment dispersion B-1. The melt viscosity of binder B-1 at 100° C. was lower than 1000 Pa·sec. The number average particle diameter of the pigment in the resulting pigment dispersion B-1 was 59 nm.

Manufacturing of Pigment Dispersion B-2

A roughly pulverized product of pigment dispersion B-2 was prepared as in pigment dispersion B-1 except that the binder B-1 was changed to binder B-2 [stearic acid (manufactured by Tokyo Chemical Industry Co., Ltd., melting point: 70° C., number average molecular weight: 286)] and that the kneading temperature was 80° C. The melt viscosity of the binder B-2 at 80° C. was lower than 1000 Pa·sec. The number average particle diameter of the pigment in the resulting pigment dispersion B-2 was 58 nm.

Manufacturing of Pigment Dispersion B-3

A roughly pulverized product of pigment dispersion B-3 was prepared as in pigment dispersion B-1 except that the binder B-1 was changed to binder B-3 [hydrocarbon wax (HNP-51, manufactured by Nippon Seiro Co., Ltd., melting point: 77° C., number average molecular weight: 522)] and that the kneading temperature was 90° C. The melt viscosity of the binder B-3 at 90° C. was lower than 1000 Pa·sec. The number average particle diameter of the pigment in the resulting pigment dispersion B-3 was 55 nm.

Manufacturing of Pigment Dispersion B-4

A roughly pulverized product of pigment dispersion B-4 was prepared as in pigment dispersion B-1 except that the binder B-1 was changed to binder B-4 [carnauba wax (Carnauba Wax manufactured by Yamakei Sangyo Co., Ltd., melting point: 83° C., number average molecular weight: 396)]. The melt viscosity of the binder B-4 at 100° C. was lower than 1000 Pa·sec. The number average particle diameter of the pigment in the resulting pigment dispersion B-4 was 56 nm.

Manufacturing of Pigment Dispersion B-5

A roughly pulverized product of pigment dispersion B-5 was prepared as in pigment dispersion B-1 except that the binder B-1 was changed to binder B-5 [hydrocarbon wax (Paraffin Wax-135, manufactured by Nippon Seiro Co., Ltd., melting point: 58° C., number average molecular weight: 370)] and that the kneading temperature was 70° C. The melt viscosity of the binder B-5 at 70° C. was lower than 1000 Pa·sec. The number average particle diameter of the pigment in the resulting pigment dispersion B-5 was 58 nm.

Manufacturing of Pigment Dispersion B-6

A roughly pulverized product of pigment dispersion B-6 was prepared as in pigment dispersion B-1 except that the binder B-1 was changed to binder B-6 [hydrocarbon wax (SX-105, manufactured by Nippon Seiro Co., Ltd., melting point: 117° C., number average molecular weight: 912)] and that the kneading temperature was 130° C. The melt viscosity of the binder B-6 at 130° C. was lower than 1000 Pa·sec. The number average particle diameter of the pigment in the resulting pigment dispersion B-6 was 59 nm.

Manufacturing of Pigment Dispersion B-7

A roughly pulverized product of pigment dispersion B-7 was prepared as in pigment dispersion B-1 except that the binder B-1 was changed to binder B-7 [polyolefin wax (NP-056, manufactured by Mitsui Chemicals, Inc., melting point: 129° C., number average molecular weight: 7000)] and that the kneading temperature was 140° C. The melt viscosity of the binder B-7 at 140° C. was lower than 1000 Pa·sec. The number average particle diameter of the pigment in the resulting pigment dispersion B-7 was 58 nm.

Manufacturing of Pigment Dispersions B-8 to B-15 and B-18 to B-28

Pigment dispersions B-8 to B-15 and B-18 to B-28 were prepared as in pigment dispersion B-1 except that the binder B-1 was changed to binder B-3 and that kneading was performed under the conditions shown in Table 6 using the grinding agents and the pigments shown in Table 5. The number average particle diameter of each of the resulting pigment dispersions are shown in Table 6.

Manufacturing of Pigment Dispersions B-16 and B-17

Roughly pulverized products of pigment dispersions B-16 and B-17 were prepared as in pigment dispersion B-3 except that the binder B-1 was changed to a mixture of binder B-3 and crystalline polyester mixed at a ratio shown in the following Table 5. The melt viscosity of the binder at 90° C. and the number average particle diameter of each of the resulting pigment dispersions are shown in Table 6.

Incidentally, the crystalline polyester in pigment dispersions B-16 and B-17 was as follows.

Crystalline polyester:
Composition (mol %) [1,6-hexanediol:dodecanedioic acid=100:100], melting point: 72° C.

In addition, in pigment dispersion B-8, a monoaxial extruder kneader was used instead of the biaxial extruder kneader.

TABLE 5

| | | | | | Grinding agent | | |
|---|---|---|---|---|---|---|---|
| Pigment | | Binder | | | | Particle | |
| dispersion | | Melting | Number average | SP value | | size | Pigment |
| No. | Type | point (° C.) | molecular weight | ((J/cm³)^{0.5}) | Type | (μm) | Type |
| B-1 | B-1 | 90 | 578 | 17.1 | Calcium carbonate | 0.4 | PB15:3 |
| B-2 | B-2 | 70 | 286 | 18.7 | Calcium carbonate | 0.4 | PB15:3 |
| B-3 | B-3 | 77 | 522 | 17.0 | Calcium carbonate | 0.4 | PB15:3 |
| B-4 | B-4 | 83 | 396 | 17.6 | Calcium carbonate | 0.4 | PB15:3 |
| B-5 | B-5 | 58 | 370 | 16.8 | Calcium carbonate | 0.4 | PB15:3 |
| B-6 | B-6 | 117 | 912 | 17.2 | Calcium carbonate | 0.4 | PB15:3 |
| B-7 | B-7 | 129 | 7000 | 17.3 | Calcium carbonate | 0.4 | PB15:3 |
| B-8 | B-3 | 77 | 578 | 17.0 | Calcium carbonate | 0.4 | PB15:3 |
| B-9 | B-3 | 77 | 578 | 17.0 | Kaolin | 0.4 | PB15:3 |
| B-10 | B-3 | 77 | 578 | 17.0 | Talc | 0.4 | PB15:3 |
| B-11 | B-3 | 77 | 578 | 17.0 | Barium sulfate | 0.4 | PB15:3 |
| B-12 | B-3 | 77 | 578 | 17.0 | Calcium carbonate | 0.2 | PB15:3 |
| B-13 | B-3 | 77 | 578 | 17.0 | Calcium carbonate | 1.0 | PB15:3 |
| B-14 | B-3 | 77 | 578 | 17.0 | Calcium carbonate | 0.1 | PB15:3 |
| B-15 | B-3 | 77 | 578 | 17.0 | Calcium carbonate | 5.0 | PB15:3 |
| B-16 | B-3:amorphous polyester = | | | | Calcium carbonate | 0.4 | PB15:3 |
| | 50 mass %:50 mass % | | | | | | |
| B-17 | B-3:amorphous polyester = | | | | Calcium carbonate | 0.4 | PB15:3 |
| | 20 mass %:80 mass % | | | | | | |
| B-18 | B-3 | 77 | 578 | 17.0 | Calcium carbonate | 0.4 | PB15:3 |
| B-19 | B-3 | 77 | 578 | 17.0 | Calcium carbonate | 0.4 | PB15:3 |
| B-20 | B-3 | 77 | 578 | 17.0 | Calcium carbonate | 0.4 | PB15:3 |
| B-21 | B-3 | 77 | 578 | 17.0 | Calcium carbonate | 0.4 | PB15:3 |
| B-22 | B-3 | 77 | 578 | 17.0 | Sodium chloride | 10 | PB15:3 |
| B-23 | B-3 | 77 | 578 | 17.0 | Calcium carbonate | 0.4 | PB15:3 |
| B-24 | B-3 | 77 | 578 | 17.0 | Calcium carbonate | 0.4 | PB15:3 |
| B-25 | B-3 | 77 | 578 | 17.0 | Calcium carbonate | 0.4 | PB15:3 |
| B-26 | B-3 | 77 | 578 | 17.0 | Calcium carbonate | 0.4 | PB15:3 |
| B-27 | B-3 | 77 | 578 | 17.0 | Calcium carbonate | 0.04 | PB15:3 |
| B-28 | B-3 | 77 | 578 | 17.0 | Calcium carbonate | 6.0 | PB15:3 |

TABLE 6

| | | | | | | | Number average | |
|---|---|---|---|---|---|---|---|---|
| | | Binder | | | | | particle size | |
| | | Melt | | | | | of pigment | |
| | | viscosity at | | Grinding | | Pigment/ | particle size | |
| | Kneading | kneading | | agent | Pigment | Grinding | Raw | After |
| Pigment | temp. | temp. | Content | Content | Content | agent | material | pulverization |
| dispersion | (° C.) | (Pa · sec) | (mass %) | (mass %) | (mass %) | Mass ratio | (nm) | (nm) |
| B-1 | 100 | <1000 | 30 | 35 | 35 | 1.0 | 102 | 59 |
| B-2 | 80 | <1000 | 30 | 35 | 35 | 1.0 | 102 | 58 |
| B-3 | 90 | <1000 | 30 | 35 | 35 | 1.0 | 102 | 55 |
| B-4 | 100 | <1000 | 30 | 35 | 35 | 1.0 | 102 | 56 |
| B-5 | 70 | <1000 | 30 | 35 | 35 | 1.0 | 102 | 58 |
| B-6 | 130 | <1000 | 30 | 35 | 35 | 1.0 | 102 | 59 |
| B-7 | 140 | <1000 | 30 | 35 | 35 | 1.0 | 102 | 58 |
| B-8 | 90 | <1000 | 30 | 35 | 35 | 1.0 | 102 | 62 |
| B-9 | 90 | <1000 | 30 | 35 | 35 | 1.0 | 102 | 59 |
| B-10 | 90 | <1000 | 30 | 35 | 35 | 1.0 | 102 | 59 |
| B-11 | 90 | <1000 | 30 | 35 | 35 | 1.0 | 102 | 58 |
| B-12 | 90 | <1000 | 30 | 35 | 35 | 1.0 | 102 | 59 |
| B-13 | 90 | <1000 | 30 | 35 | 35 | 1.0 | 102 | 58 |
| B-14 | 90 | <1000 | 30 | 35 | 35 | 1.0 | 102 | 62 |
| B-15 | 90 | <1000 | 30 | 35 | 35 | 1.0 | 102 | 63 |
| B-16 | 90 | <1000 | 30 | 35 | 35 | 1.0 | 102 | 58 |
| B-17 | 90 | <1000 | 30 | 35 | 35 | 1.0 | 102 | 60 |
| B-18 | 90 | <1000 | 30 | 58.3 | 11.7 | 0.2 | 102 | 63 |
| B-19 | 90 | <1000 | 30 | 28 | 42 | 1.5 | 102 | 62 |
| B-20 | 90 | <1000 | 5 | 47.5 | 47.5 | 1.0 | 102 | 62 |
| B-21 | 90 | <1000 | 50 | 25 | 25 | 1.0 | 102 | 63 |
| B-22 | 90 | <1000 | 30 | 35 | 35 | 1.0 | 102 | 58 |
| B-23 | 90 | <1000 | 30 | 61.4 | 8.6 | 0.14 | 102 | 53 |
| B-24 | 90 | <1000 | 30 | 26.9 | 43.1 | 1.6 | 102 | 90 |
| B-25 | 90 | <1000 | 4 | 48 | 48 | 1.0 | 102 | 87 |
| B-26 | 90 | <1000 | 55 | 22.5 | 22.5 | 1.0 | 102 | 82 |
| B-27 | 90 | <1000 | 30 | 35 | 35 | 1.0 | 102 | 93 |
| B-28 | 90 | <1000 | 30 | 35 | 35 | 1.0 | 102 | 64 |

Manufacturing Example of Toner B-1

Amorphous polyester I: 77.7 parts
(Composition (mol %) [polyoxypropylene (2.2)-2,2-bis(4-hydroxyphenyl)propane:isophthalic acid:terephthalic acid=100:50:50], softening point (Tm): 122° C., glass transition temperature (Tg): 70° C., SP value: 22.6 (J/cm³)^{0.5}) Pigment dispersion B-1: 14.3 parts Hydrocarbon wax: 8.0 parts (Peak temperature of maximum endothermic peak: 90° C.)

The above-mentioned materials were mixed using a Henschel mixer (FM-75 type, manufactured by Nippon Coke & Engineering Co., Ltd.) at a rotation speed of 20 s⁻¹ for a rotation time of 5 minutes and were then melted and kneaded with a biaxial kneader (PCM-30 type, manufactured by Ikegai Corporation). The resulting kneaded product was cooled and was roughly pulverized with a pin mill to a volume average particle diameter of 100 μm or less to obtain a roughly pulverized product. The resulting roughly pulverized product was finely pulverized with a mechanical pulverizer (T-250, manufactured by Freund-Turbo Corporation) by adjusting the rotation speed and the number of passes so as to obtain a target particle diameter. Furthermore, classification was performed using a rotary classifier (200TSP, manufactured by Hosokawa Micron Corporation) to obtain toner particles having a weight average particle diameter of 6.5 μm. As the operational conditions of the rotary classifier (200TSP, manufactured by Hosokawa Micron Corporation), the rotation speed was adjusted so that target particle diameter and particle size distribution were obtained, and classification was performed.

Silica microparticles (BET specific surface area: 200 m²/g, 1.8 parts) hydrophobized with silicone oil were added to the resulting toner particles (100 parts), and the mixture was mixed with a Henschel mixer (FM-75 type, manufactured by Nippon Coke & Engineering Co., Ltd.) at a rotation speed of 30 s⁻¹ for a rotation time of 10 minutes to obtain toner B-1.

Manufacturing Examples of Toners B-2 to B-7, B-9 to B-18, and B-21 to B-32

Toners B-2 to B-7, B-9 to B-18, and B-21 to B-32 were manufactured as in toner B-1 except that materials and conditions were changed to those shown Table 7.

In addition, toners B-26 to B-32 manufactured using pigment dispersions B-22 to B-28 are described as Comparative Examples.

Manufacturing Example of Toner B-8

Toner B-8 was manufactured as in toner B-1 except that the following amorphous polyester II was used instead of amorphous polyester I.

### Amorphous Polyester II:

Composition (mol %) [polyoxypropylene (2.2)-2,2-bis(4-hydroxyphenyl)propane:fumaric acid:terephthalic acid=100:76:24], softening point (Tm): 106° C., glass transition temperature (Tg): 59° C., SP value: 21.7 (J/cm³)^{0.5}

Manufacturing Example of Toner B-19

Pigment dispersion B-3 (60 parts), toluene (150 parts) as a solvent, and glass beads (diameter: 1 mm, 130 parts) were mixed and were subjected to dispersion with an attritor [manufactured by Nippon Coke & Engineering Co., Ltd.] for 3 hours to obtain a dispersion liquid.

Subsequently, trisodium phosphate dodecahydrate (manufactured by FUJIFILM Wako Pure Chemical Corporation, 11.7 parts) and deionized water (1200 parts) were added to a beaker set to a water bath to dissolve the trisodium phosphate dodecahydrate. Subsequently, the temperature of the water bath was raised to 60° C. After reaching 60° C., an aqueous solution prepared by dissolving calcium chloride (manufactured by Kishida Chemical Co., Ltd., 5.15 parts) in deionized water (100 parts) was added thereto. After the addition, stirring was performed for 30 minutes to obtain an aqueous medium containing tricalcium phosphate.

Amorphous polyester I: 80.0 parts
The above dispersion liquid: 50.0 parts
Hydrocarbon wax (peak temperature of maximum endothermic peak: 90° C.): 5.7 parts
Toluene: 350.0 parts

The above-mentioned materials were mixed and were heated to 80° C. while stirring to dissolve and disperse each material to produce a resin composition.

Separately, the aqueous medium (600 parts) containing tricalcium phosphate was heated to 80° C. while stirring with CLEARMIX (manufactured by M Technique Co., Ltd.). A resin composition was added to the aqueous medium containing tricalcium phosphate, followed by stirring at 10000 rpm for 10 minutes to obtain a dispersion liquid. The resulting dispersion liquid was stirred using a stirring blade at 80° C. for 5 hours to remove toluene and was then cooled to 25° C. over 10 minutes to obtain an aqueous dispersion of toner particles.

A dilute hydrochloric acid was added to the resulting aqueous dispersion liquid of toner particles while stirring. Tricalcium phosphate was dissolved by stirring at pH 1.5 for 2 hours, and solid-liquid separation with a filter was then performed to obtain toner particles.

The toner particles were put into water, followed by stirring to obtain a dispersion liquid again. The dispersion was then subjected to solid-liquid separation with a filter. This procedure was repeated until the tricalcium phosphate was sufficiently removed, and the resulting particles were sufficiently dried with a drier to obtain toner particles.

The resulting toner particles were subjected to external addition in the same manner as the toner B-1 to obtain toner B-19.

Manufacturing Example of Toner B-20

Styrene: 50.9 parts
n-Butyl acrylate: 16.1 parts
Pigment dispersion B-7: 14.3 parts
Hydrocarbon wax (peak temperature of maximum endothermic peak: 90° C.): 15.7 parts
Amorphous polyester I: 3.0 parts

A mixture of the above-mentioned materials was prepared. The mixture was put into an attritor (manufactured by Nippon Coke & Engineering Co., Ltd.) and was dispersed using zirconia beads having a diameter of 5 mm at 200 rpm for 2 hours to obtain a raw material dispersion liquid.

Separately, deionized water (735.0 parts) and trisodium phosphate (dodecahydrate) (16.0 parts) were added to a container equipped with a high speed stirring device homomixer (manufactured by PRIMIX Corporation) and a thermometer, and the temperature was raised to 60° C. while stirring at 12000 rpm. A calcium chloride aqueous solution prepared by dissolving calcium chloride (dihydrate) (9.0 parts) in deionized water (65.0 parts) was then put into the container, followed by stirring at 12000 rpm for 30 minutes while maintaining the temperature at 60° C. The pH was adjusted to 6.0 by adding 10% hydrochloric acid thereto to obtain an aqueous medium containing a dispersion stabilizer.

Subsequently, the raw material dispersion liquid was transferred to a container equipped with a stirrer and a thermometer, and the temperature was raised to 60° C. while stirring at 100 rpm. As a polymerization initiator, t-butyl peroxypivalate (Perbutyl PV, manufactured by NOF Corporation, 8.0 parts) was added thereto, followed by stirring at 100 rpm for 5 minutes while maintaining 60° C. The resulting mixture was then put into the aqueous medium that was being stirred with the high speed stirring device at 12000 rpm. Stirring with the high speed stirring device was continued at 12000 rpm for 20 minutes while maintaining 60° C. to obtain a granulation liquid. The granulation liquid was transferred to a reaction container equipped with a reflux condenser tube, a stirrer, a thermometer, and a nitrogen introduction pipe and was heated to 70° C. while stirring at 150 rpm under a nitrogen atmosphere. While maintaining 70° C., the polymerization reaction was performed at 150 rpm for 10 hours. Subsequently, the reflux condenser tube was removed from the reaction container, and the reaction solution was heated to 95° C. and was stirred at 150 rpm for 5 hours while maintaining 95° C. to obtain a toner-particle dispersion liquid.

The resulting toner-particle dispersion liquid was cooled to 20° C. while stirring at 150 rpm, and dilute hydrochloric acid was added thereto until the pH reached 1.5 while continuing the stirring to dissolve the dispersion stabilizer. The solid content was collected by filtration and was sufficiently washed with deionized water and was then vacuum dried at 40° C. for 24 hours to obtain toner particles.

The resulting toner particles were subjected to external addition in the same manner as the toner B-1 to obtain toner B-20.

Manufacturing Example of Toner B-21

Manufacturing of Amorphous Resin Microparticles

Tetrahydrofuran (manufactured by FUJIFILM Wako Pure Chemical Corporation): 200 parts
Amorphous polyester I: 120 parts
Anionic surfactant (NEOGEN RK, manufactured by DKS Co., Ltd.): 0.6 parts

The above-mentioned materials were mixed and were stirred for 12 hours to dissolve the resin.

Subsequently, N,N-dimethylaminoethanol (2.7 g) was added to the above-obtained solution, followed by stirring using an ultra-high speed stirring device T.K. ROBOMIX (manufactured by PRIMIX Corporation) at 4000 rpm.

Furthermore, deionized water (359.4 parts) was added thereto at a rate of 1 g/min to precipitate resin microparticles. Subsequently, tetrahydrofuran was removed using an evaporator to obtain amorphous resin microparticles and a dispersion liquid thereof

Manufacturing of Pigment Dispersion Microparticles

Pigment dispersion B-3: 10.0 parts
Anionic surfactant (NEOGEN RK, manufactured by DKS Co., Ltd.): 0.5 parts
Deionized water: 89.5 parts

The above-mentioned materials were mixed and were heated and dissolved at 90° C. and were dispersed using a high pressure impact disperser Nano-Mizer (manufactured by Yoshida Kikai Co., Ltd.) for about 1 hour to prepare a dispersion liquid of pigment dispersion microparticles in which the pigment dispersion was dispersed in water.

Manufacturing of Release Agent Microparticles

Hydrocarbon wax (peak temperature of maximum endothermic peak: 90° C.): 20.0 parts
Anionic surfactant (NEOGEN RK, manufactured by DKS Co., Ltd.): 1.0 parts
Deionized water: 79.0 parts

The above materials were put into a mixing container equipped with a stirrer and were then heated to 90° C. and were stirred with a shear stirring unit of a rotor outer diameter of 3 cm and a clearance of 0.3 mm under conditions of a rotor rotation speed of 19000 rpm and a screen rotation speed of 19000 rpm while circulating in CLEARMIX W-MOTION (manufactured by M Technique Co., Ltd.) to perform dispersion treatment for 60 minutes.

Subsequently, a dispersion liquid of release agent microparticles was obtained by cooling to 40° C. under cooling treatment conditions of a rotor rotation speed of 1000 rpm, a screen rotation speed of 0 rpm, and a cooling rate of 10° C./min.

An example of the method for manufacturing a toner using the above dispersion liquid is as follows.

Dispersion liquid of amorphous polyester I: 320 parts
Dispersion liquid of pigment dispersion microparticles: 143 parts
Dispersion liquid of release agent microparticles: 28.5 parts
Deionized water: 400 parts

The above-mentioned materials were put into a round stainless beaker and were mixed, and an aqueous solution in which 2 parts of magnesium sulfate was dissolved in 98 parts of deionized water was then added to the beaker to perform dispersion using a homogenizer (manufactured by IKA: ULTRA-TURRAX T50) at 5000 rpm for 10 minutes.

Subsequently, the mixture solution was heated to 58° C. while appropriately controlling the rotation speed such that the mixture solution was stirred using a stirring blade in a water bath for heating. The temperature of 58° C. was maintained for 1 hour to obtain aggregate particles.

An aqueous solution in which 20 parts of trisodium citrate was dissolved relative to 380 parts of deionized water was further added to the dispersion liquid containing the aggregate particles, followed by heating to 95° C.

The aggregate particles were maintained at 95° C. for 2 hours, followed by cooling to 25° C. while continuing the stirring to obtain a toner-particle dispersion liquid.

Subsequently, filtration and solid-liquid separation were performed, and the residue was sufficiently washed with deionized water and was dried with a vacuum dryer to obtain toner particles.

The resulting toner particles were subjected to external addition in the same manner as the toner B-1 to obtain toner B-21.

TABLE 7

| | | | | Resin for toner (Resin A) | | | | | |
|---|---|---|---|---|---|---|---|---|---|
| | | | | | Absolute | | | | |
| | | | | | value of | | | | |
| | Pigment dispersion | | | | difference | | | | |
| | | | SP value | | in SP value with | | | Toner particles | |
| | | | of low | | low molecular | | | | Weight |
| | | | molecular | | crystalline | | Wax | | average |
| | | Addition | amorphous | | compound | Addition | Addition | | particle |
| Toner | | amount | compound | SP value | dispersion | amount | amount | Manufacturing | size |
| No. | No. | (parts) | ((J/cm³)^{0.5}) | ((J/cm³)^{0.5}) | ((J/cm³)^{0.5}) | (parts) | (parts) | method | (μm) |
| B-1 | B-1 | 14.3 | 17.1 | 22.6 | 5.5 | 82.0 | 3.7 | Kneading crushing | 6.5 |
| B-2 | B-2 | 14.3 | 18.7 | 22.6 | 3.9 | 77.7 | 8 | Kneading crushing | 6.5 |
| B-3 | B-3 | 14.3 | 17.0 | 22.6 | 5.6 | 82.0 | 3.7 | Kneading crushing | 6.5 |
| B-4 | B-4 | 14.3 | 17.6 | 22.6 | 5.1 | 82.0 | 3.7 | Kneading crushing | 6.5 |
| B-5 | B-5 | 14.3 | 16.8 | 22.6 | 5.8 | 82.0 | 3.7 | Kneading crushing | 6.5 |
| B-6 | B-6 | 14.3 | 17.2 | 22.6 | 5.4 | 82.0 | 3.7 | Kneading crushing | 6.5 |
| B-7 | B-7 | 14.3 | 17.3 | 22.6 | 5.3 | 82.0 | 3.7 | Kneading crushing | 6.5 |
| B-8 | B-3 | 14.3 | 17.0 | 21.7 | 4.7 | 82.0 | 3.7 | Kneading crushing | 6.5 |
| B-9 | B-8 | 14.3 | 17.0 | 22.6 | 5.6 | 82.0 | 3.7 | Kneading crushing | 6.5 |
| B-10 | B-9 | 14.3 | 17.0 | 22.6 | 5.6 | 82.0 | 3.7 | Kneading crushing | 6.5 |
| B-11 | B-10 | 14.3 | 17.0 | 22.6 | 5.6 | 82.0 | 3.7 | Kneading crushing | 6.5 |
| B-12 | B-11 | 14.3 | 17.0 | 22.6 | 5.6 | 82.0 | 3.7 | Kneading crushing | 6.5 |
| B-13 | B-12 | 14.3 | 17.0 | 22.6 | 5.6 | 82.0 | 3.7 | Kneading crushing | 6.5 |
| B-14 | B-13 | 14.3 | 17.0 | 22.6 | 5.6 | 82.0 | 3.7 | Kneading crushing | 6.5 |
| B-15 | B-14 | 14.3 | 17.0 | 22.6 | 5.6 | 82.0 | 3.7 | Kneading crushing | 6.5 |
| B-16 | B-15 | 14.3 | 17.0 | 22.6 | 5.6 | 82.0 | 3.7 | Kneading crushing | 6.5 |
| B-17 | B-16 | 14.3 | 17.0 | 22.6 | 5.6 | 79.8 | 5.9 | Kneading crushing | 6.5 |
| B-18 | B-17 | 14.3 | 17.0 | 22.6 | 5.6 | 78.6 | 7.1 | Kneading crushing | 6.5 |
| B-19 | B-3 | 14.3 | 17.0 | 22.6 | 5.6 | 80.0 | 5.7 | Dissolution | 6.5 |
| | | | | | | | | suspension method | |
| B-20 | B-3 | 14.3 | 17.0 | 21.1 | 4.1 | 67.0 | 5.7 | Suspension | 6.5 |
| | | | | | | | | polymerization | |
| | | | | | | | | method | |
| B-21 | B-3 | 14.3 | 17.0 | 22.6 | 5.6 | 80.0 | 5.7 | Emulsification | 6.5 |
| | | | | | | | | aggregation method | |
| B-22 | B-18 | 25.7 | 17.0 | 22.6 | 5.6 | 74.0 | 0.3 | Kneading crushing | 6.5 |
| B-23 | B-19 | 11.9 | 17.0 | 22.6 | 5.6 | 83.7 | 4.4 | Kneading crushing | 6.5 |
| B-24 | B-20 | 10.5 | 17.0 | 22.6 | 5.6 | 82.0 | 7.5 | Kneading crushing | 6.5 |
| B-25 | B-21 | 20.0 | 17.0 | 22.6 | 5.6 | 80.0 | 0.0 | Kneading crushing | 6.5 |
| B-26 | B-22 | 14.3 | 17.0 | 22.6 | 5.6 | 82.0 | 3.7 | Kneading crushing | 6.5 |
| B-27 | B-23 | 28.1 | 17.0 | 22.6 | 5.6 | 71.9 | 0.0 | Kneading crushing | 6.5 |
| B-28 | B-24 | 11.6 | 17.0 | 22.6 | 5.6 | 83.9 | 4.5 | Kneading crushing | 6.5 |
| B-29 | B-25 | 10.4 | 17.0 | 22.6 | 5.6 | 82.0 | 7.6 | Kneading crushing | 6.5 |
| B-30 | B-26 | 22.2 | 17.0 | 22.6 | 5.6 | 77.8 | 0.0 | Kneading crushing | 6.5 |
| B-31 | B-27 | 14.3 | 17.0 | 22.6 | 5.6 | 82.0 | 3.7 | Kneading crushing | 6.5 |
| B-32 | B-28 | 14.3 | 17.0 | 22.6 | 5.6 | 82.0 | 3.7 | Kneading crushing | 6.5 |

### Manufacturing Example of Two-Component Developer B-1

A magnetic carrier having a coat layer of a copolymer of cyclohexyl methacrylate, methyl methacrylate, and methyl methacrylate macromonomer formed on the surface of Mn—Mg—Sr ferrite carrier core and having a 50% particle diameter (D50) of 38.2 μm on a volume distribution basis was prepared.

This magnetic carrier (92.0 parts) and toner B-1 (8.0 parts) were mixed with a V-shape rotating mixer (V-20, manufactured by Seishin Enterprise Co., Ltd.) to obtain two-component developer B-1.

Manufacturing Example of Two-Component Developers B-2 to B-32

Two-component developers B-2 to B-32 were manufactured as in the Manufacturing Example of two-component developer B-1 except that toner B-1 was changed to toners B-2 to B-32, respectively.

### Evaluation of Grindability

In the manufacturing process of each toner, 1000 kg of roughly pulverized product was pulverized using a mechanical pulverizer (T-250, manufactured by Freund-Turbo Corporation) to produce a finely pulverized product having a weight average particle diameter of 6.2 μm. The power consumption of the mechanical pulverizer on this occasion was measured, and the obtained value was used as an indicator of grindability. Incidentally, the power consumption in the toner B-27 was defined as standard power consumption, and evaluation was performed by the following criteria. The smaller the power consumption, the better the grindability and the higher the productivity. The results are shown in Table 8.

### Evaluation Criteria

A: less than 90% of the standard power consumption;
B: 90% or more and less than 110% of the standard power consumption; and
C: 110% or more of the standard power consumption.

### Method for Evaluating Coloring Power of Toner

As the image forming apparatus, a modified apparatus of a full-color copier image RUNNER ADVANCE C5255 manufactured by CANON KABUSHIKI KAISHA was used, and each two-component developer was put into the developing unit of the cyan station and was evaluated.

The evaluation environment was a normal temperature and normal humidity environment (23° C., 50% RH), and as the evaluation paper, plain copy paper GFC-081 (A4, basis weight: 81.4 g/m², available from Canon Marketing Japan Inc.) was used.

First, in the evaluation environment, the relationship between the image density and the toner bearing amount on paper was investigated by changing the toner bearing amount on the paper.

Subsequently, the image density of the FFH image (solid portion) was adjusted to 1.40, and the toner bearing amount when the image density reached 1.40 was determined.

The FFH image was the value displaying 256 tones in hexadecimal, and OOH was defined as the 1st tone (white portion), and FFH was defined as the 256th tone (solid portion).

The image density was measured using an X-Rite color reflection densitometer (500 series: manufactured by X-Rite Inc.).

The coloring power of a toner was evaluated from the toner bearing amount (mg/cm²) by the following criteria. The evaluation results are shown in Table 8.

### Evaluation Criteria

A: less than 0.35
B: 0.35 or more and less than 0.50
C: 0.50 or more and less than 0.65
D: 0.65 or more

### Evaluation of Charge Retention Ability

The triboelectric charging amount of a toner was measured using each two-component developer, and the chargeability of the toner was evaluated by the following criteria.

The triboelectric charging amount of a toner was measured with Espart Analyzer of Hosokawa Micron Corporation.

The triboelectric charging amount of an initial toner was measured, and the triboelectric charging amount was measured again using each two-component developer left to stand in a thermo-hygrostat (temperature: 30° C., humidity: 80% RH) for one week.

The retention rate of the triboelectric charging amount was calculated by substituting the measurement result for the following equation and was evaluated by the following criteria. The evaluation results are shown in Table 8.

Triboelectric charging amount retention rate (%) of toner=[triboelectric charging amount of toner after one week]/[triboelectric charging amount of initial toner]×100

### Evaluation Criteria

A: The triboelectric charging amount retention rate is 80% or more,
B: The triboelectric charging amount retention rate is 60% or more and less than 80%, and
C: The triboelectric charging amount retention rate is less than 60%.

TABLE 8

| | | | | Charge |
|---|---|---|---|---|
| | | | Coloring | retention |
| Toner | Developer | Grindability | power | ability |
| B-1 | B-1 | A | B | A |
| B-2 | B-2 | A | B | B |
| B-3 | B-3 | A | B | A |
| B-4 | B-4 | A | B | A |
| B-5 | B-5 | A | B | A |
| B-6 | B-6 | A | B | A |
| B-7 | B-7 | A | C | A |
| B-8 | B-8 | B | B | B |
| B-9 | B-9 | B | C | A |
| B-10 | B-10 | A | C | B |
| B-11 | B-11 | A | C | B |
| B-12 | B-12 | A | C | A |
| B-13 | B-13 | A | B | A |
| B-14 | B-14 | A | B | A |
| B-15 | B-15 | A | C | A |
| B-16 | B-16 | A | C | B |
| B-17 | B-17 | A | B | B |
| B-18 | B-18 | A | B | B |
| B-19 | B-19 | — | B | A |
| B-20 | B-20 | — | B | B |
| B-21 | B-21 | — | B | A |
| B-22 | B-22 | A | C | B |
| B-23 | B-23 | B | C | A |
| B-24 | B-24 | A | C | A |
| B-25 | B-25 | A | C | A |
| B-26 | B-26 | C | B | C |
| B-27 | B-27 | A | D | C |
| B-28 | B-28 | B | D | A |
| B-29 | B-29 | A | D | A |
| B-30 | B-30 | A | D | A |
| B-31 | B-31 | A | D | A |
| B-32 | B-32 | A | D | C |

In toner B-26, since filtration washing and drying process were not performed, the toner contained a salt, resulting in unacceptable chargeability. In addition, the grindability at the time of pulverization was reduced by the influence of the salt.

In toner B-27, since the amount of grinding agent relative to the pigment was small, pulverization was insufficient, and the pigment particle diameter was large, resulting in unacceptable coloring power.

In toner B-28, since the amount of grinding agent relative to the pigment was too large, the charge retention ability and the coloring power when formed into a toner were reduced, resulting in unacceptable results.

In toner B-29, since the amount of the binder in the pigment dispersion was small, the pigment and the grinding agent could not be sufficiently mixed, and the pigment particle diameter was large, resulting in unacceptable coloring power.

In toner B-30, since the amount of the binder in the pigment dispersion was too large, the pigment crushing property by the grinding agent was deteriorated, and the pigment particle diameter was large, resulting in unacceptable coloring power.

In toner B-31, since the particle diameter of the grinding agent was small, crushing of the pigment by the grinding agent was decreased, and since the pigment particle diameter was large, resulting in unacceptable coloring power.

In toner B-32, since the particle diameter of the grinding agent was large, the charge retention ability and the coloring power when formed into a toner were reduced, resulting in unacceptable results.

Manufacturing of Pigment Dispersion C-1

Pigment: 35 parts
(Cyan pigment: Pigment Blue 15:3, volume average particle diameter: 102 nm)
Grinding agent: 35 parts
(Precipitated calcium carbonate, number average particle diameter: 0.4 μm)
Binder C-1: 30 parts
(Crystalline polyester: composition (mol %) [sebacic acid:nonanediol=50:50], melting point (Tp): 72° C., SP value: 19.8 (J/cm³)^{0.5})

The above-mentioned materials were mixed using a Henschel mixer (FM-75 type, manufactured by Nippon Coke & Engineering Co., Ltd.) at a rotation speed of 20 s⁻¹ for a rotation time of 5 minutes and were then kneaded with a biaxial kneader (PCM-30 type, manufactured by Ikegai Corporation) at 85° C. The resulting kneaded product was cooled and was roughly pulverized with a pin mill to a volume average particle diameter of 100 μm or less to obtain a roughly pulverized product of pigment dispersion C-1. The melt viscosity of binder C-1 at 85° C. was lower than 1000 Pa·sec. The number average particle diameter of the pigment in the resulting pigment dispersion C-1 was 52 nm.

Manufacturing of Pigment Dispersion C-2

A roughly pulverized product of pigment dispersion C-2 was prepared as in pigment dispersion C-1 except that the binder C-1 was changed to binder C-2 [crystalline vinyl resin (composition (mol %) [behenyl acrylate:acrylonitrile:styrene=25.3:59.5:15.2], melting point (Tp): 62° C., SP value: 20.7 (J/cm³)^{0.5})] and that kneading was performed at 75° C. The melt viscosity of the binder C-2 at 75° C. was 2200 Pa·sec. The number average particle diameter of the pigment in the resulting pigment dispersion C-2 was 49 nm.

Manufacturing of Pigment Dispersion C-3

A roughly pulverized product of pigment dispersion C-3 was prepared as in pigment dispersion C-1 except that the binder C-1 was changed to binder C-3 [crystalline polyester (composition (mol %) [decanedicarboxylic acid:hexanediol=50:50], melting point (Tp): 75° C., SP value: 19.9 (J/cm³)^{0.5})]. The melt viscosity of the binder C-3 at 85° C. was lower than 1000 Pa·sec. The number average particle diameter of the pigment in the resulting pigment dispersion C-3 was 51 nm.

Manufacturing of Pigment Dispersions C-4 to C-11 and C-14 to C-28

Table 10 shows the number average particle diameters of the pigments in pigment dispersions C-4 to C-11 and C-14 to C-28 prepared using the binders, the grinding agents, and the pigments shown in Table 9 and kneading under conditions shown in Table 10.

Incidentally, the amorphous polyester in pigment dispersions C-14 and C-15 was as follows: amorphous polyester: composition (mol %) [polyoxypropylene (2.2)-2,2-bis(4-hydroxyphenyl)propane:isophthalic acid:terephthalic acid=100:50:50], softening point (Tm): 122° C., glass transition temperature (Tg): 70° C., SP value: 22.6 (J/cm³)^{0.5}

In addition, in pigment dispersion C-4, a monoaxial extruder kneader was used instead of the biaxial extruder kneader.

Manufacturing of Pigment Dispersion C-12

A roughly pulverized product of pigment dispersion C-12 was prepared as in pigment dispersion C-1 except that the binder C-1 was changed to binder C-4 [crystalline polyester, number average molecular weight: about 6000, melting point (Tp): 71° C., SP value: 18.8 (J/cm³)^{0.5}] and that the kneading temperature was 75° C. The melt viscosity of the binder C-4 at 75° C. was lower than 1000 Pa·sec. The number average particle diameter of the pigment in the resulting pigment dispersion C-12 was 52 nm.

Manufacturing of Pigment Dispersion C-13

A roughly pulverized product of pigment dispersion C-13 was prepared as in pigment dispersion C-1 except that the binder C-1 was changed to binder C-5 [crystalline polyester, number average molecular weight: about 2000, melting point (Tp): 69° C., SP value: 18.3 (J/cm³)^{0.5}] and the kneading temperature was 75° C. The melt viscosity of the binder C-5 at 75° C. was lower than 1000 Pa·sec. The number average particle diameter of the pigment in the resulting pigment dispersion C-13 was 53 nm.

TABLE 9

| | Binder | | | | | |
|---|---|---|---|---|---|---|
| | | | SP value of | Grinding agent | | |
| Pigment | | Melting | crystalline | | Particle | |
| dispersion | | point Tp | resin | | size | Pigment |
| No. | Type | (° C.) | ((J/cm³)^{0.5}) | Type | (μm) | Type |
| C-1 | Binder C-1 | 72 | 19.8 | Calcium carbonate | 0.4 | PB 15:3 |
| C-2 | Binder C-2 | 62 | 20.7 | Calcium carbonate | 0.4 | PB 15:3 |
| C-3 | Binder C-3 | 72 | 19.9 | Calcium carbonate | 0.4 | PB 15:3 |
| C-4 | Binder C-1 | 72 | 19.8 | Calcium carbonate | 0.4 | PB 15:3 |
| C-5 | Binder C-1 | 72 | 19.8 | Kaolinite | 0.4 | PB 15:3 |
| C-6 | Binder C-1 | 72 | 19.8 | Talc | 1.0 | PB 15:3 |
| C-7 | Binder C-1 | 72 | 19.8 | Barium sulfate | 0.5 | PB 15:3 |
| C-8 | Binder C-1 | 72 | 19.8 | Calcium carbonate | 0.2 | PB 15:3 |
| C-9 | Binder C-1 | 72 | 19.8 | Calcium carbonate | 1.0 | PB 15:3 |
| C-10 | Binder C-1 | 72 | 19.8 | Calcium carbonate | 0.1 | PB 15:3 |
| C-11 | Binder C-1 | 72 | 19.8 | Calcium carbonate | 5.0 | PB 15:3 |
| C-12 | Binder C-4 | 71 | 18.8 | Calcium carbonate | 0.4 | PB 15:3 |
| C-13 | Binder C-5 | 69 | 18.3 | Calcium carbonate | 0.4 | PB 15:3 |
| C-14 | Binder C-1: | 75 | 19.8 | Calcium carbonate | 0.4 | PB 15:3 |
| | amorphous | | | | | |
| | polyester = | | | | | |
| | 50 mass %: | | | | | |
| | 50 mass % | | | | | |
| C-15 | Binder C-1: | 75 | 19.8 | Calcium carbonate | 0.4 | PB 15:3 |
| | amorphous | | | | | |
| | polyester = | | | | | |
| | 20 mass %: | | | | | |
| | 80 mass % | | | | | |
| C-16 | Binder C-1 | 75 | 19.8 | Calcium carbonate | 0.4 | PB 15:3 |
| C-17 | Binder C-1 | 75 | 19.8 | Calcium carbonate | 0.4 | PB 15:3 |
| C-18 | Binder C-1 | 75 | 19.8 | Calcium carbonate | 0.4 | PB 15:3 |
| C-19 | Binder C-1 | 75 | 19.8 | Calcium carbonate | 0.4 | PB 15:3 |
| C-20 | Binder C-1 | 75 | 19.8 | Calcium carbonate | 0.4 | PR 122 |
| C-21 | Binder C-1 | 75 | 19.8 | Calcium carbonate | 0.4 | PY 180 |
| C-22 | Binder C-1 | 75 | 19.8 | Sodium chloride | 10 | PB 15:3 |
| C-23 | Binder C-1 | 75 | 19.8 | Calcium carbonate | 0.4 | PB 15:3 |
| C-24 | Binder C-1 | 75 | 19.8 | Calcium carbonate | 0.4 | PB 15:3 |
| C-25 | Binder C-1 | 75 | 19.8 | Calcium carbonate | 0.4 | PB 15:3 |
| C-26 | Binder C-1 | 75 | 19.8 | Calcium carbonate | 0.4 | PB 15:3 |
| C-27 | Binder C-1 | 75 | 19.8 | Calcium carbonate | 0.04 | PB 15:3 |
| C-28 | Binder C-1 | 75 | 19.8 | Calcium carbonate | 6.0 | PB 15:3 |

TABLE 10

| | | Binder | | | | | Number average | |
|---|---|---|---|---|---|---|---|---|
| | | Melt | | | | Pigment/ | particle size | |
| | | viscosity at | | Grinding | | Grinding | of pigment | |
| Pigment | Kneading | kneading | | agent | Pigment | agent | Raw | After |
| dispersion | temp. | temp. | Content | Content | Content | Mass | material | pulverization |
| No. | (° C.) | (Pa · sec) | (mass %) | (mass %) | (mass %) | ratio | (nm) | (nm) |
| C-1 | 85 | <1000 | 30 | 35 | 35 | 1.0 | 102 | 52 |
| C-2 | 75 | 2200 | 30 | 35 | 35 | 1.0 | 102 | 49 |
| C-3 | 85 | <1000 | 30 | 35 | 35 | 1.0 | 102 | 51 |
| C-4 | 85 | <1000 | 30 | 35 | 35 | 1.0 | 102 | 59 |
| C-5 | 85 | <1000 | 30 | 35 | 35 | 1.0 | 102 | 57 |
| C-6 | 85 | <1000 | 30 | 35 | 35 | 1.0 | 102 | 58 |
| C-7 | 85 | <1000 | 30 | 35 | 35 | 1.0 | 102 | 57 |
| C-8 | 85 | <1000 | 30 | 35 | 35 | 1.0 | 102 | 59 |
| C-9 | 85 | <1000 | 30 | 35 | 35 | 1.0 | 102 | 58 |
| C-10 | 85 | <1000 | 30 | 35 | 35 | 1.0 | 102 | 63 |
| C-11 | 85 | <1000 | 30 | 35 | 35 | 1.0 | 102 | 62 |
| C-12 | 75 | <1000 | 30 | 35 | 35 | 1.0 | 102 | 52 |
| C-13 | 75 | <1000 | 30 | 35 | 35 | 1.0 | 102 | 53 |
| C-14 | 120 | <1000 | 30 | 35 | 35 | 1.0 | 102 | 55 |
| C-15 | 120 | 1220 | 30 | 35 | 35 | 1.0 | 102 | 57 |
| C-16 | 85 | <1000 | 30 | 58.3 | 11.7 | 0.2 | 102 | 49 |
| C-17 | 85 | <1000 | 30 | 28 | 42 | 1.5 | 102 | 61 |
| C-18 | 85 | <1000 | 5 | 47.5 | 47.5 | 1.0 | 102 | 60 |
| C-19 | 85 | <1000 | 50 | 25 | 25 | 1.0 | 102 | 61 |
| C-20 | 85 | <1000 | 30 | 35 | 35 | 1.0 | 80 | 41 |
| C-21 | 85 | <1000 | 30 | 35 | 35 | 1.0 | 150 | 41 |
| C-22 | 85 | <1000 | 30 | 35 | 35 | 1.0 | 102 | 57 |
| C-23 | 85 | <1000 | 30 | 61.4 | 8.6 | 0.14 | 102 | 47 |
| C-24 | 85 | <1000 | 30 | 26.9 | 43.1 | 1.6 | 102 | 74 |
| C-25 | 85 | <1000 | 4 | 48 | 48 | 1.0 | 102 | 80 |
| C-26 | 85 | <1000 | 55 | 22.5 | 22.5 | 1.0 | 102 | 81 |
| C-27 | 85 | <1000 | 30 | 35 | 35 | 1.0 | 102 | 83 |
| C-28 | 85 | <1000 | 30 | 35 | 35 | 1.0 | 102 | 82 |

Manufacturing Example of Toner C-1

Amorphous polyester: 77.7 parts
(Composition (mol %) [polyoxypropylene (2.2)-2,2-bis(4-hydroxyphenyl)propane:isophthalic acid:terephthalic acid=100:50:50], softening point (Tm): 122° C., glass transition temperature (Tg): 70° C., SP value: 22.6 (J/cm³)^{0.5})
Pigment dispersion C-1: 14.3 parts
Hydrocarbon wax: 8.0 parts
(Peak temperature of maximum endothermic peak: 90° C.)

The above-mentioned materials were mixed using a Henschel mixer (FM-75 type, manufactured by Nippon Coke & Engineering Co., Ltd.) at a rotation speed of 20 s⁻¹ for a rotation time of 5 minutes and were then kneaded with a biaxial kneader (PCM-30 type, manufactured by Ikegai Corporation). The resulting kneaded product was cooled and was roughly pulverized with a pin mill to a volume average particle diameter of 100 μm or less to obtain a roughly pulverized product. The resulting roughly pulverized product was finely pulverized with a mechanical pulverizer (T-250, manufactured by Freund-Turbo Corporation) by adjusting the rotation speed and the number of passes so as to obtain a target particle diameter. Furthermore, classification was performed using a rotary classifier (200TSP, manufactured by Hosokawa Micron Corporation) to obtain toner particles having a weight average particle diameter of 6.5 μm. As the operational conditions of the rotary classifier (200TSP, manufactured by Hosokawa Micron Corporation), the rotation speed was adjusted so that target particle diameter and particle size distribution were obtained, and classification was performed.

Silica microparticles (BET specific surface area: 200 m²/g, 1.8 parts) hydrophobized with silicone oil were added to the resulting toner particles (100 parts), and the mixture was mixed with a Henschel mixer (FM-75 type, manufactured by Nippon Coke & Engineering Co., Ltd.) at a rotation speed of 30 s⁻¹ for a rotation time of 10 minutes to obtain toner C-1.

Manufacturing Examples of Toners C-2 to C-12, C-14 to C-19, and C-23 to C-32

Toners C-2 to C-12, C-14 to C-19, and C-23 to C-32 were manufactured as in toner C-1 except that materials and conditions were changed to those shown in Table 11.

Incidentally, in toner C-12, the amorphous polyester was changed to the following crystalline vinyl resin.

Crystalline vinyl resin (composition (mol %) [behenyl acrylate:acrylonitrile:styrene=25.3:59.5:15.2], melting point (Tp): 62° C., SP value: 20.7 (J/cm³)^{0.5})

In addition, in toner C-14, the amorphous polyester was changed to the following amorphous polyester.

Amorphous polyester: composition (mol %) [polyoxyethylene (2.2)-2,2-bis(4-hydroxyphenyl)propane:terephthalic acid:trimellitic acid=100:80:20], softening point (Tm): 135° C., glass transition temperature (Tg): 69° C., SP value: 23.6 (J/cm³)°

In addition, toners C-26 to C-32 manufactured using pigment dispersions C-22 to C-28 are described as Comparative Examples.

Manufacturing Example of Toner C-13

Toner C-13 was manufactured as in toner C-1 except that the amorphous polyester was changed to the following amorphous polyester.

Amorphous polyester: composition (mol %) [polyoxyethylene (2.2)-2,2-bis(4-hydroxyphenyl)propane:terephthalic acid:trimellitic acid=100:80:20], softening point (Tm): 135° C., glass transition temperature (Tg): 69° C., SP value: 23.6 (J/cm³)^{0.5}

Manufacturing Example of Toner C-21

Pigment dispersion C-1 (60 parts), toluene (150 parts) as a solvent, and glass beads (diameter: 1 mm, 130 parts) were mixed and were subjected to dispersion with an attritor [manufactured by Nippon Coke & Engineering Co., Ltd.] for 3 hours to obtain a dispersion liquid.

Subsequently, trisodium phosphate dodecahydrate (manufactured by FUJIFILM Wako Pure Chemical Corporation, 11.7 parts) and deionized water (1200 parts) were added to a beaker set to a water bath to dissolve the trisodium phosphate dodecahydrate. Subsequently, the temperature of the water bath was raised to 60° C. After reaching 60° C., an aqueous solution prepared by dissolving calcium chloride (manufactured by Kishida Chemical Co., Ltd., 5.15 parts) in deionized water (100 parts) was added thereto. After the addition, stirring was performed for 30 minutes to obtain an aqueous medium containing tricalcium phosphate.

Amorphous polyester: 75.7 parts
(Composition (mol %) [polyoxypropylene (2.2)-2,2-bis(4-hydroxyphenyl)propane:isophthalic acid:terephthalic acid=100:50:50], softening point (Tm): 122° C., glass transition temperature (Tg): 70° C., SP value: 22.6 (J/cm³)^{0.5})
The above dispersion liquid: 50.0 parts
Hydrocarbon wax (peak temperature of maximum endothermic peak: 90° C.): 10.0 parts
Toluene: 350.0 parts

The above-mentioned materials were mixed and were heated to 80° C. while stirring to dissolve and disperse each material to produce a resin composition.

Separately, the aqueous medium (600 parts) containing tricalcium phosphate was heated to 80° C. while stirring with CLEARMIX (manufactured by M Technique Co., Ltd.). A resin composition was added to the aqueous medium containing tricalcium phosphate, followed by stirring at 10000 rpm for 10 minutes to obtain a dispersion liquid. The resulting dispersion liquid was stirred using a stirring blade at 80° C. for 5 hours to remove toluene and was then cooled to 25° C. over 10 minutes to obtain an aqueous dispersion of toner particles.

Dilute hydrochloric acid was added to the resulting aqueous dispersion liquid of toner particles while stirring. The tricalcium phosphate was dissolved by stirring at pH 1.5 for 2 hours, and solid-liquid separation with a filter was then performed to obtain toner particles.

The toner particles were put into water, followed by stirring to obtain a dispersion liquid again. The dispersion was then subjected to solid-liquid separation with a filter. This procedure was repeated until the tricalcium phosphate was sufficiently removed, and the resulting particles were sufficiently dried with a drier to obtain toner particles.

The resulting toner particles were subjected to external addition in the same manner as the toner C-1 to obtain toner C-21.

Manufacturing Example of Toner C-22

Styrene: 47.6 parts
n-Butyl acrylate: 15.1 parts
Pigment dispersion C-1: 14.3 parts
Hydrocarbon wax (peak temperature of maximum endothermic peak: 90° C.): 20.0 parts
Amorphous polyester: 3.0 parts
(Composition (mol %) [polyoxypropylene (2.2)-2,2-bis(4-hydroxyphenyl)propane:isophthalic acid:terephthalic acid=100:50:50], softening point (Tm): 122° C., glass transition temperature (Tg): 70° C., SP value: 22.6 (J/cm³)^{0.5})

A mixture of the above-mentioned materials was prepared. The mixture was put into an attritor (manufactured by Nippon Coke & Engineering Co., Ltd.) and was dispersed using zirconia beads having a diameter of 5 mm at 200 rpm for 2 hours to obtain a raw material dispersion liquid.

Separately, deionized water (735.0 parts) and trisodium phosphate (dodecahydrate) (16.0 parts) were added to a container equipped with a high speed stirring device homomixer (manufactured by PRIMIX Corporation) and a thermometer, and the temperature was raised to 60° C. while stirring at 12000 rpm. A calcium chloride aqueous solution prepared by dissolving calcium chloride (dihydrate) (9.0 parts) in deionized water (65.0 parts) was then put into the container, followed by stirring at 12000 rpm for 30 minutes while maintaining 60° C. The pH was adjusted to 6.0 by adding 10% hydrochloric acid thereto to obtain an aqueous medium containing a dispersion stabilizer.

Subsequently, the raw material dispersion liquid was transferred to a container equipped with a stirrer and a thermometer, and the temperature was raised to 60° C. while stirring at 100 rpm. As a polymerization initiator, t-butyl peroxypivalate (Perbutyl PV, manufactured by NOF Corporation, 8.0 parts) was added thereto, followed by stirring at 100 rpm for 5 minutes while maintaining 60° C. The resulting mixture was then put into the aqueous medium that was being stirred with the high speed stirring device at 12000 rpm. Stirring with the high speed stirring device was continued at 12000 rpm for 20 minutes while maintaining 60° C. to obtain a granulation liquid. The granulation liquid was transferred to a reaction container equipped with a reflux condenser tube, a stirrer, a thermometer, and a nitrogen introduction pipe and was heated to 70° C. while stirring at 150 rpm under a nitrogen atmosphere. While maintaining 70° C., the polymerization reaction was performed at 150 rpm for 10 hours. Subsequently, the reflux condenser tube was removed from the reaction container, and the reaction solution was heated to 95° C. and was stirred at 150 rpm for 5 hours while maintaining 95° C. to obtain a toner-particle dispersion liquid.

The resulting toner-particle dispersion liquid was cooled to 20° C. while stirring at 150 rpm, and dilute hydrochloric acid was added thereto until the pH reached 1.5 while continuing the stirring to dissolve the dispersion stabilizer. The solid content was collected by filtration and was sufficiently washed with deionized water and was then vacuum dried at 40° C. for 24 hours to obtain toner particles.

The resulting toner particles were subjected to external addition in the same manner as the toner C-1 to obtain toner C-22.

Manufacturing Example of Toner C-23

Manufacturing of Amorphous Resin Microparticles

Tetrahydrofuran (manufactured by FUJIFILM Wako Pure Chemical Corporation): 200 parts
Amorphous polyester: 120 parts
(Composition (mol %) [polyoxypropylene (2.2)-2,2-bis(4-hydroxyphenyl)propane:isophthalic acid:terephthalic acid=100:50:50], softening point (Tm): 122° C., glass transition temperature (Tg): 70° C., SP value: 22.6 (J/cm³)^{0.5})
Anionic surfactant (NEOGEN RK manufactured by DKS Co., Ltd.): 0.6 parts

The above-mentioned materials were mixed and were stirred for 12 hours to dissolve the resin.

Subsequently, N,N-dimethylaminoethanol (2.7 parts) was added to above-obtained solution, followed by stirring using an ultra-high speed stirring device T.K. ROBOMIX (manufactured by PRIMIX Corporation) at 4000 rpm.

Furthermore, deionized water (359.4 parts) was added thereto at a rate of 1 g/min to precipitate resin microparticles. Subsequently, tetrahydrofuran was removed using an evaporator to obtain amorphous resin microparticles and a dispersion liquid thereof

Manufacturing of Pigment Dispersion Microparticles

Pigment dispersion C-1: 24.0 parts
Methyl ethyl ketone: 76.0 parts

The above materials were gradually put into a container and were stirred to completely dissolve and were set to 40° C., and N,N-dimethylaminoethanol (0.1 parts) was added thereto while stirring, and then an aqueous solution prepared by mixing NEOGEN RK (manufactured by DKS Co., Ltd., 1.5 parts) with deionized water (74.5 parts) was gradually added thereto for phase-transfer emulsification. Furthermore, the solvent was removed by reducing the pressure, followed by dispersion using a high pressure impact disperser Nano-Mizer (manufactured by Yoshida Kikai Co., Ltd.) for about 1 hour to prepare a dispersion liquid of pigment dispersion microparticles in which the pigment dispersion was dispersed in water.

Manufacturing of Release Agent Microparticles

Hydrocarbon wax (peak temperature of maximum endothermic peak: 90° C.): 10.0 parts
Anionic surfactant (NEOGEN RK manufactured by DKS Co., Ltd.): 1.0 parts
Deionized water: 89.0 parts

The above materials were put into a mixing container equipped with a stirrer and were then heated to 90° C. and were stirred with a shear stirring unit of a rotor outer diameter of 3 cm and a clearance of 0.3 mm under conditions of a rotor rotation speed of 19000 rpm and a screen rotation speed of 19000 rpm while circulating in CLEARMIX W-MOTION (manufactured by M Technique Co., Ltd.) to perform dispersion treatment for 60 minutes.

Subsequently, a dispersion liquid of release agent microparticles was obtained by cooling to 40° C. under cooling treatment conditions of a rotor rotation speed of 1000 rpm, a screen rotation speed of 0 rpm, and a cooling rate of 10° C./min.

An example of the method for manufacturing a toner using the above dispersion liquid is as follows.

Dispersion liquid of amorphous polyester: 302.8 parts
Dispersion liquid of pigment dispersion microparticles: 59.6 parts
Dispersion liquid of release agent microparticles: 100.0 parts
Deionized water: 400.0 parts

The above-mentioned materials were put into a round stainless beaker and were mixed, and an aqueous solution in which 2 parts of magnesium sulfate was dissolved in 98 parts of deionized water was then added to the beaker to perform dispersion using a homogenizer (manufactured by IKA: ULTRA-TURRAX T50) at 5000 rpm for 10 minutes.

Subsequently, the mixture solution was heated to 58° C. while appropriately controlling the rotation speed such that the mixture solution was stirred using a stirring blade in a water bath for heating. The temperature of 58° C. was maintained for 1 hour to obtain aggregate particles.

An aqueous solution in which 20 parts of trisodium citrate was dissolved relative to 380 parts of deionized water was further added to the dispersion liquid containing the aggregate particles, followed by heating to 95° C.

The aggregate particles were maintained at 95° C. for 2 hours, followed by cooling to 25° C. while continuing the stirring to obtain a toner-particle dispersion liquid.

Subsequently, filtration and solid-liquid separation were performed, and the residue was sufficiently washed with deionized water and was dried with a vacuum dryer to obtain toner particles.

The resulting toner particles were subjected to external addition in the same manner as the toner C-1 to obtain toner C-23.

TABLE 11

| | | | | Binder resin | | | | | |
|---|---|---|---|---|---|---|---|---|---|
| | | | | | Absolute value | | | | |
| | | | | | of difference | | | | |
| | | | | | in SP value | | | | |
| | Pigment dispersion | | | | with | | | | |
| | | | SP | | crystalline | | | | |
| | | Addition | value of | | resin in | | Wax | Toner particles | |
| | | amount | crystalline | SP value of | pigment | Addition | Addition | | Particle |
| Toner | | (parts by | resin | main resin | dispersion | amount | amount | Manufacturing | size |
| No. | No. | mass) | ((J/cm³)^{0.5}) | ((J/cm³)^{0.5}) | ((J/cm³)^{0.5}) | (parts) | (parts) | method | (μm) |
| C-1 | C-1 | 14.3 | 19.8 | 22.6 | 2.8 | 77.7 | 8.0 | Kneading crushing | 6.5 |
| C-2 | C-2 | 14.3 | 20.7 | 22.6 | 1.9 | 77.7 | 8.0 | Kneading crushing | 6.5 |
| C-3 | C-3 | 14.3 | 19.9 | 22.6 | 2.7 | 77.7 | 8.0 | Kneading crushing | 6.5 |
| C-4 | C-4 | 14.3 | 19.8 | 22.6 | 2.8 | 77.7 | 8.0 | Kneading crushing | 6.5 |
| C-5 | C-5 | 14.3 | 19.8 | 22.6 | 2.8 | 77.7 | 8.0 | Kneading crushing | 6.5 |
| C-6 | C-6 | 14.3 | 19.8 | 22.6 | 2.8 | 77.7 | 8.0 | Kneading crushing | 6.5 |
| C-7 | C-7 | 14.3 | 19.8 | 22.6 | 2.8 | 77.7 | 8.0 | Kneading crushing | 6.5 |
| C-8 | C-8 | 14.3 | 19.8 | 22.6 | 2.8 | 77.7 | 8.0 | Kneading crushing | 6.5 |
| C-9 | C-9 | 14.3 | 19.8 | 22.6 | 2.8 | 77.7 | 8.0 | Kneading crushing | 6.5 |
| C-10 | C-10 | 14.3 | 19.8 | 22.6 | 2.8 | 77.7 | 8.0 | Kneading crushing | 6.5 |
| C-11 | C-11 | 14.3 | 19.8 | 22.6 | 2.8 | 77.7 | 8.0 | Kneading crushing | 6.5 |
| C-12 | C-2 | 14.3 | 20.7 | 20.7 | 0.0 | 77.7 | 8.0 | Kneading crushing | 6.5 |
| C-13 | C-12 | 14.3 | 18.8 | 23.6 | 4.8 | 77.7 | 8.0 | Kneading crushing | 6.5 |
| C-14 | C-13 | 14.3 | 18.3 | 23.6 | 5.3 | 77.7 | 8.0 | Kneading crushing | 6.5 |
| C-15 | C-14 | 14.3 | 19.8 | 22.6 | 2.8 | 77.7 | 8.0 | Kneading crushing | 6.5 |
| C-16 | C-15 | 14.3 | 19.8 | 22.6 | 2.8 | 77.7 | 8.0 | Kneading crushing | 6.5 |
| C-17 | C-16 | 25.7 | 19.8 | 22.6 | 2.8 | 66.3 | 8.0 | Kneading crushing | 6.5 |
| C-18 | C-17 | 11.9 | 19.8 | 22.6 | 2.8 | 80.1 | 8.0 | Kneading crushing | 6.5 |
| C-19 | C-18 | 10.5 | 19.8 | 22.6 | 2.8 | 81.5 | 8.0 | Kneading crushing | 6.5 |
| C-20 | C-19 | 20.0 | 19.8 | 22.6 | 2.8 | 72.0 | 8.0 | Kneading crushing | 6.5 |
| C-21 | C-1 | 14.3 | 19.8 | 22.6 | 2.8 | 75.7 | 10.0 | Dissolution | 6.5 |
| | | | | | | | | suspension | |
| C-22 | C-1 | 14.3 | — | 21.1 | — | 62.7 | 20.0 | Suspension | 6.5 |
| | | | | | | | | polymerization | |
| C-23 | C-1 | 14.3 | 19.8 | 22.6 | 2.8 | 75.7 | 10.0 | Emulsification | 6.5 |
| | | | | | | | | aggregation | |
| C-24 | C-20 | 14.3 | 19.8 | 22.6 | 2.8 | 77.7 | 8.0 | Kneading crushing | 6.5 |
| C-25 | C-21 | 14.3 | 19.8 | 22.6 | 2.8 | 77.7 | 8.0 | Kneading crushing | 6.5 |
| C-26 | C-22 | 14.3 | 19.8 | 22.6 | 2.8 | 77.7 | 8.0 | Kneading crushing | 6.5 |
| C-27 | C-23 | 28.1 | 19.8 | 22.6 | 2.8 | 63.9 | 8.0 | Kneading crushing | 6.5 |
| C-28 | C-24 | 11.6 | 19.8 | 22.6 | 2.8 | 80.4 | 8.0 | Kneading crushing | 6.5 |
| C-29 | C-25 | 10.4 | 19.8 | 22.6 | 2.8 | 81.6 | 8.0 | Kneading crushing | 6.5 |
| C-30 | C-26 | 22.2 | 19.8 | 22.6 | 2.8 | 69.8 | 8.0 | Kneading crushing | 6.5 |
| C-31 | C-27 | 14.3 | 19.8 | 22.6 | 2.8 | 77.7 | 8.0 | Kneading crushing | 6.5 |
| C-32 | C-28 | 14.3 | 19.8 | 22.6 | 2.8 | 77.7 | 8.0 | Kneading crushing | 6.5 |

Manufacturing Example of Two-Component Developer C-1

A magnetic carrier having a coat layer of a copolymer of cyclohexyl methacrylate, methyl methacrylate, and methyl methacrylate macromonomer formed on the surface of Mn—Mg—Sr ferrite carrier core and having a 50% particle diameter (D50) of 38.2 μm on a volume distribution basis was prepared.

This magnetic carrier (92.0 parts) and toner C-1 (8.0 parts) were mixed with a V-shape rotating mixer (V-20, manufactured by Seishin Enterprise Co., Ltd.) to obtain two-component developer C-1.

Manufacturing Examples of Two-Component Developers C-2 to C-32

Two-component developers C-2 to C-32 were manufactured as in the Manufacturing Example of two-component developer C-1 except that toner C-1 was changed to toners C-2 to C-32, respectively.

### Method for Evaluating Coloring Power of Toner

As the image forming apparatus, a modified apparatus of a full-color copier image RUNNER ADVANCE C5255 manufactured by CANON KABUSHIKI KAISHA was used, and each two-component developer was put into the developing unit of the cyan station and was evaluated.

The evaluation environment was a normal temperature and normal humidity environment (23° C., 50% RH), and as the evaluation paper, plain copy paper GFC-081 (A4, basis weight: 81.4 g/m², available from Canon Marketing Japan Inc.) was used.

First, in the evaluation environment, the relationship between the image density and the toner bearing amount on paper was investigated by changing the toner bearing amount on the paper.

Subsequently, the image density of the FFH image (solid portion) was adjusted to 1.40, and the toner bearing amount when the image density reached 1.40 was determined.

The FFH image was the value displaying 256 tones in hexadecimal, and OOH was defined as the 1st tone (white portion), and FFH was defined as the 256th tone (solid portion).

The image density was measured using an X-Rite color reflection densitometer (500 series: manufactured by X-Rite Inc.).

The coloring power of a toner was evaluated from the toner bearing amount (mg/cm²) by the following criteria. The evaluation results are shown in Table 12.

### Evaluation Criteria

A: less than 0.35
B: 0.35 or more and less than 0.50
C: 0.50 or more and less than 0.65
D: 0.65 or more

Evaluation of Low-Temperature Fixability of Toner

Paper: GFC-081 (81.0 g/m²)
(available from Canon Marketing Japan Inc.)
Toner bearing amount on paper: 0.50 mg/cm²
(adjustment by direct current voltage VDC of developer bearing member, electrification voltage VD of electrostatic latent image bearing member, and laser power)
Evaluation image: a 2 cm×5 cm image placed in the center of the above-mentioned A4 size paper
Test environment: low temperature and low humidity environment, temperature: 15° C., humidity: 10% RH (hereinafter, “L/L”)
Fixing temperature: 130° C.
Process speed: 377 mm/sec

The evaluation image was output, and the low-temperature fixability was evaluated. The value of image density-decreasing rate was used as the evaluation indicator of low-temperature fixability. The image density-decreasing rate was calculated by measuring the image density in the center portion using an X-Rite color reflection densitometer (500 series: manufactured by X-Rite Inc.), then rubbing (5 reciprocations) the fixed image with lens-cleaning paper while applying a load of 4.9 kPa (50 g/cm²) to the portion where the image density was measured, and measuring the image density again. The image density-decreasing rate after the rubbing was calculated by the following equation. The obtained image density-decreasing rate was evaluated according to the following evaluation criteria.

Image density-decreasing rate=[(image density before rubbing)−(image density after rubbing)]/(image density before rubbing)×100

### Evaluation Criteria

A: image density-decreasing rate of less than 3.0%
B: image density-decreasing rate of 3.0% or more and less than 10.0%
C: image density-decreasing rate of 10.0% or more and less than 15.0%
D: image density-decreasing rate of 15.0% or more

### Evaluation of Charge Retention Ability of Toner

The triboelectric charging amount of a toner was measured using each two-component developer, and the chargeability of the toner was evaluated by the following criteria.

The triboelectric charging amount of a toner was measured with Espart Analyzer of Hosokawa Micron Corporation.

The triboelectric charging amount of an initial toner was measured, and the triboelectric charging amount was measured again using a two-component developer left to stand in a thermo-hygrostat (temperature: 30° C., humidity: 80% RH) for one week.

The retention rate of the triboelectric charging amount was calculated by substituting the measurement result for the following equation and was evaluated by the following criteria. The evaluation results are shown in Table 12.

Triboelectric charging amount retention rate (%) of toner=[triboelectric charging amount of toner after one week]/[triboelectric charging amount of initial toner]×100

### Evaluation Criteria

A: The triboelectric charging amount retention rate is 80% or more,
B: The triboelectric charging amount retention rate is 60% or more and less than 80%, and
C: The triboelectric charging amount retention rate is less than 60%.

TABLE 12

| | | | Low- | Charge |
|---|---|---|---|---|
| | | Coloring | temperature | retention |
| Toner | Developer | power | fixability | ability |
| C-1 | C-1 | B | A | B |
| C-2 | C-2 | B | A | A |
| C-3 | C-3 | B | A | B |
| C-4 | C-4 | C | A | B |
| C-5 | C-5 | C | A | B |
| C-6 | C-6 | C | A | B |
| C-7 | C-7 | C | A | B |
| C-8 | C-8 | B | B | A |
| C-9 | C-9 | B | B | B |
| C-10 | C-10 | C | C | A |
| C-11 | C-11 | C | C | B |
| C-12 | C-12 | A | A | A |
| C-13 | C-13 | B | B | B |
| C-14 | C-14 | B | C | B |
| C-15 | C-15 | A | B | B |
| C-16 | C-16 | A | C | B |
| C-17 | C-17 | B | C | B |
| C-18 | C-18 | C | A | B |
| C-19 | C-19 | C | C | A |
| C-20 | C-20 | C | A | B |
| C-21 | C-21 | B | A | B |
| C-22 | C-22 | B | B | B |
| C-23 | C-23 | B | A | B |
| C-24 | C-24 | A | A | B |
| C-25 | C-25 | A | A | B |
| C-26 | C-26 | B | A | C |
| C-27 | C-27 | A | D | B |
| C-28 | C-28 | D | B | A |
| C-29 | C-29 | D | C | A |
| C-30 | C-30 | D | A | C |
| C-31 | C-31 | D | A | B |
| C-32 | C-32 | D | B | C |

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2020-209350 filed Dec. 17, 2020, which is hereby incorporated by reference herein in its entirety.

What is claimed is:

1. A method for manufacturing a toner, comprising:
a pigment crushing step of kneading a pigment, a binder, and a grinding agent to obtain a pigment dispersion in which the grinding agent and the crushed pigment are dispersed in the binder; and
a step of obtaining toner particles by at least any one of the following processes (i) to (v) using the pigment dispersion, wherein
the binder is a thermoplastic component that is water-insoluble and is a solid at 25°;
the grinding agent is a particle that is water-insoluble and has a number average particle diameter of 0.1 to 5.0 μm;
the proportion of the binder based on the mass of the pigment dispersion is 5 to 50 mass %;
the mass ratio of the pigment to the grinding agent in the pigment dispersion is 0.2 to 1.5;
in the pigment crushing step, the kneading is performed at a temperature at which the melt viscosity of the binder is 6000 Pa·sec or less; and
the toner particles contain the binder and the grinding agent,
(i) a process for obtaining toner particles through a step of melt-kneading the pigment dispersion and a resin A and a step of pulverizing the resulting kneaded product;
(ii) a process for obtaining toner particles through a step of preparing a resin solution in which the pigment dispersion and a resin A are dissolved to an organic solvent, a step of dispersing the resulting resin solution in an aqueous medium and performing granulation to form a droplet particle A, and a step of removing the organic solvent contained in the droplet particle A;
(iii) a process for obtaining toner particles containing a resin A formed by polymerization of a polymerizable monomer through a step of mixing the pigment dispersion and the polymerizable monomer to prepare a polymerizable monomer composition, a step of dispersing the polymerizable monomer composition in an aqueous medium and performing granulation to form a droplet particle B, and a step of polymerizing the polymerizable monomer contained in the droplet particle B;
(iv) a process for obtaining toner particles through a step of mixing a dispersion liquid containing microparticles of the pigment dispersion and a dispersion liquid containing microparticles containing a resin A and aggregating these microparticles to form aggregate particles and a step of heating and fusing the aggregate particles; and
(v) a process for obtaining toner particles through a step of preparing a resin composition containing the pigment dispersion and a resin A, a step of preparing a dispersion liquid containing microparticles of the resin composition, a step of aggregating the microparticles to form aggregate particles, and a step of heating and fusing the aggregate particles.

2. The method for manufacturing a toner according to claim 1, wherein
the amount of the grinding agent in the toner particles is 20 mass % or less based on the mass of the toner particles.

3. The method for manufacturing a toner according to claim 1, wherein
the grinding agent includes one type of particle selected from the group consisting of an inorganic salt particle, an inorganic oxide particle, and a mineral particle.

4. The method for manufacturing a toner according to claim 1, wherein
the binder includes 20 mass % or more of an amorphous resin; and
the amorphous resin has a glass transition temperature of 30° C. to 80° C. and a softening point Tm of 80° C. to 200° C.

5. The method for manufacturing a toner according to claim 4, wherein
the binder contains 50 mass % or more of the amorphous resin.

6. The method for manufacturing a toner according to claim 4, wherein
the amorphous resin has a glass transition temperature Tg of 50° C. to 70° C.

7. The method for manufacturing a toner according to claim 4, wherein
the amorphous resin has a softening point Tm of 100° C. to 150° C.

8. The method for manufacturing a toner according to claim 4, wherein
the difference between SP values of the amorphous resin and the resin A is 3.0 (J/cm³)^{0.5} or less.

9. The method for manufacturing a toner according to claim 4, wherein
the amorphous resin has an SP value of 21.0 to 24.0 (J/cm³)^{0.5}.

10. The method for manufacturing a toner according to claim 4, wherein
the amorphous resin is amorphous polyester.

11. The method for manufacturing a toner according to claim 1, wherein
the binder includes 20 mass % or more of a low molecular weight crystalline compound having a number average molecular weight of 250 or more and 1000 or less.

12. The method for manufacturing a toner according to claim 11, wherein
the binder includes 50 mass % or more of the low molecular weight crystalline compound.

13. The method for manufacturing a toner according to claim 11, wherein
the low molecular weight crystalline compound has a melting point of 60° C. to 120° C.

14. The method for manufacturing a toner according to claim 1, wherein
the binder includes 20 mass % or more of a crystalline resin having a melting point of 60° C. to 120° C.

15. The method for manufacturing a toner according to claim 1, wherein
the grinding agent has a number average particle diameter of 0.2 to 1.0 μm.

16. The method for manufacturing a toner according to claim 1, wherein
the grinding agent is calcium carbonate particles.
